(19) United States
(12) Patent Application Publication
(10) Pub. No.: US 2024/0159161 A1
(43) Pub. Date: May 16, 2024

(54) TEMPERATURE MEASUREMENT SYSTEM AND TEMPERATURE MEASUREMENT METHOD

(71) Applicant: MITSUBISHI HEAVY INDUSTRIES, LTD., Tokyo (JP)

(72) Inventors: Keisho OMICHI, Tokyo (JP); Tetsuya YAMASAKI, Tokyo (JP); Hidekazu YAMASHITA, Tokyo (JP); Kenta WADA, Tokyo (JP); Tomohisa TAKASAKI, Yokohama-shi (JP)

(21) Appl. No.: 18/383,136

(22) Filed: Oct. 24, 2023

(30) Foreign Application Priority Data
Nov. 11, 2022 (JP) 2022-181070

(51) Int. Cl. F01D 21/00; G01K 15/00

(52) U.S. Cl. CPC F01D 21/003; G01K 15/007; G01K 2205/00

(57) ABSTRACT

A temperature measurement system includes first and second temperature measurement sections for a plurality of small regions, a temperature deviation calculation section configured to obtain a temperature deviation between a first measured temperature and a second measured temperature, change rate calculation sections configured to obtain a first temperature change rate in the first measured temperature and a second temperature change rate in the second measured temperature, representative change rate calculation sections configured to obtain a representative change rate relating to the first temperature change rate and the second temperature change rate for each of the small regions, and change rate abnormality determination sections configured to compare the representative change rate with the first temperature change rate and the second temperature change rate used in calculation of an abnormality deviation exceeding a temperature deviation threshold value and determine whether or not the first and second temperature measurement sections are abnormal.

### BACKGROUND OF THE INVENTION

### Field of the Invention

The present disclosure relates to a temperature measurement system and a temperature measurement method.

Priority is claimed on Japanese Patent Application No. 2022-181070, filed Nov. 11, 2022, the content of which is incorporated herein by reference.

### Description of Related Art

A temperature measurement system is described in the following Patent Document 1. This system has a plurality of thermocouples arranged around a combustor of a gas turbine to monitor the combustor. Each of the plurality of thermocouples is of a double-element type. The double-element type thermocouple has two temperature measurement sections in one sheath tube. Consequently, this system has redundancy in the temperature measurement sections that measure a temperature in one region around the combustor.

### PATENT DOCUMENTS

[Patent Document 1] Japanese Unexamined Patent Application, First Publication No. H8-135470

### SUMMARY OF THE INVENTION

In the technology described in Patent Document 1, the temperature in one region can only be measured by two temperature measurement sections and it is not known which of temperatures measured by the two temperature measurement sections should be used for monitoring the combustor when one of the two temperature measurement sections becomes abnormal.

Therefore, an objective of the present disclosure is to provide technology for ascertaining which of two temperature measurement sections becomes abnormal when one of the two temperature measurement sections becomes abnormal in a state in which the two temperature measurement sections are provided in one region.

According to an aspect for achieving the above-described objective, there is provided a temperature measurement system including: first and second temperature measurement sections provided for each of a plurality of small regions into which a large region where a normal temperature range is predetermined is divided in a measurement target and configured to measure a temperature within the small region; a temperature deviation calculation section provided for each of the plurality of small regions and configured to obtain a temperature deviation, which is the difference between a first measured temperature, which is a temperature measured by the first temperature measurement section, and a second measured temperature, which is a temperature measured by the second temperature measurement section; a deviation abnormality determination section provided for each of the plurality of small regions and configured to determine whether or not the temperature deviation exceeds a predetermined temperature deviation threshold value; change rate calculation sections provided for each of the plurality of small regions and configured to obtain a first temperature change rate, which is the change rate per unit time in the first measured temperature, and a second temperature change rate, which is the change rate per unit time in the second measured temperature; representative change rate calculation sections configured to obtain a representative change rate, which is a value representative of the temperature change rate for each of the plurality of small regions, using the first temperature change rate and the second temperature change rate for each of the plurality of small regions; and change rate abnormality determination sections provided for each of the plurality of small regions and configured to compare the representative change rate with the first temperature change rate relating to a target first measured temperature, which is the first measured temperature used in calculation of an abnormality deviation, which is the temperature deviation exceeding the temperature deviation threshold value, when the temperature deviation exceeds the temperature deviation threshold value, compare the representative change rate with the second temperature change rate relating to a target second measured temperature, which is the second measured temperature used in the calculation of the abnormality deviation, and determine whether or not the first temperature measurement section measuring the target first measured temperature is abnormal and whether or not the second temperature measurement section measuring the target second measured temperature is abnormal.

In the present aspect, it is determined whether or not the temperature deviation, which is the difference between the first measured temperature, which is the temperature measured by the first temperature measurement section disposed in one small region, and the second measured temperature, which is the temperature measured by the second temperature measurement section disposed in the small region, exceeds the predetermined temperature deviation threshold value. When the temperature deviation exceeds the temperature deviation threshold value, at least one temperature measurement section between the first temperature measurement section and the second temperature measurement section is likely to be abnormal. In this case, in the present aspect, the first temperature change rate relating to the target first measured temperature, which is the first measured temperature used in the calculation of the abnormality deviation, which is the temperature deviation exceeding the temperature deviation threshold value, is compared with the representative change rate obtained using the first temperature change rate and the second temperature change rate for each of the plurality of small regions. In the present aspect, furthermore, the representative change rate is compared with the second temperature change rate relating to the target second measured temperature, which is the second measured temperature used in the calculation of the abnormality deviation. Also, in the present aspect, the change rate abnormality determination section determines whether or not the first temperature measurement section measuring the target first measured temperature is abnormal and whether or not the second temperature measurement section measuring the target second measured temperature is abnormal from these comparison results.

According to an aspect for achieving the above-described objective, there is provided a temperature measurement method including: a first temperature measurement step of measuring a temperature of a small region for each of a plurality of small regions into which a large region where a normal temperature range is predetermined is divided in a measurement target in a first temperature measurement section; a second temperature measurement step of measuring a temperature of a small region for each of the plurality of small regions in a second temperature measurement section; a temperature deviation calculation step of obtaining a temperature deviation, which is the difference between a first measured temperature, which is a temperature measured in the first temperature measurement step, and a second measured temperature, which is a temperature measured in the second temperature measurement step, for each of the plurality of small regions; a deviation abnormality determination step of determining whether or not the temperature deviation exceeds a predetermined temperature deviation threshold value for each of the plurality of small regions; change rate calculation steps of obtaining a first temperature change rate, which is the change rate per unit time in the first measured temperature, and a second temperature change rate, which is the change rate per unit time in the second measured temperature for each of the plurality of small regions; representative change rate calculation steps of obtaining a representative change rate, which is a value representative of the temperature change rate for each of the plurality of small regions, using the first temperature change rate and the second temperature change rate for each of the plurality of small regions; and change rate abnormality determination steps of comparing the representative change rate with the first temperature change rate relating to a target first measured temperature, which is the first measured temperature used in calculation of an abnormality deviation, which is the temperature deviation exceeding the temperature deviation threshold value, when the temperature deviation exceeds the temperature deviation threshold value for each of the plurality of small regions, comparing the representative change rate with the second temperature change rate relating to a target second measured temperature, which is the second measured temperature used in the calculation of the abnormality deviation, and determining whether or not the first temperature measurement section measuring the target first measured temperature is abnormal and whether or not the second temperature measurement section measuring the target second measured temperature is abnormal.

In the present aspect, as in the temperature measurement system according to the above-described aspect, it is possible to determine whether or not the first temperature measurement section measuring the target first measured temperature is abnormal and whether or not the second temperature measurement section measuring the target second measured temperature is abnormal.

In an aspect of the present disclosure, it is possible to ascertain which of two temperature measurement sections becomes abnormal when one of the two temperature measurement sections becomes abnormal in a state in which the two temperature measurement sections are provided in one region.

### BRIEF DESCRIPTION OF THE DRAWINGS

FIG. 1 is a schematic configuration diagram of a gas turbine facility in an embodiment according to the present disclosure.

FIG. 2 is a functional block diagram of a temperature measurement system in the embodiment according to the present disclosure.

FIG. 3 is an explanatory diagram showing a first temperature measurement section and a second temperature measurement section in the embodiment according to the present disclosure.

FIG. 4 is an explanatory diagram showing a first temperature measurement section and a second temperature measurement section in a modified example of the embodiment according to the present disclosure.

FIG. 5 is a functional block diagram of a signal processing section, a short-time representative change rate calculation section, and a long-time representative change rate calculation section in the embodiment according to the present disclosure.

FIG. 6 is a flowchart showing an operation of the temperature measurement system in the embodiment according to the present disclosure.

FIG. 7 is an explanatory diagram showing relationships between various types of conditions and an abnormal determination result in the embodiment according to the present disclosure.

### DETAILED DESCRIPTION OF THE INVENTION

Hereinafter, embodiments of a temperature measurement system and a measurement target of the temperature measurement system according to the present invention will be described with reference to the drawings.

### “Embodiment of Measurement Target”

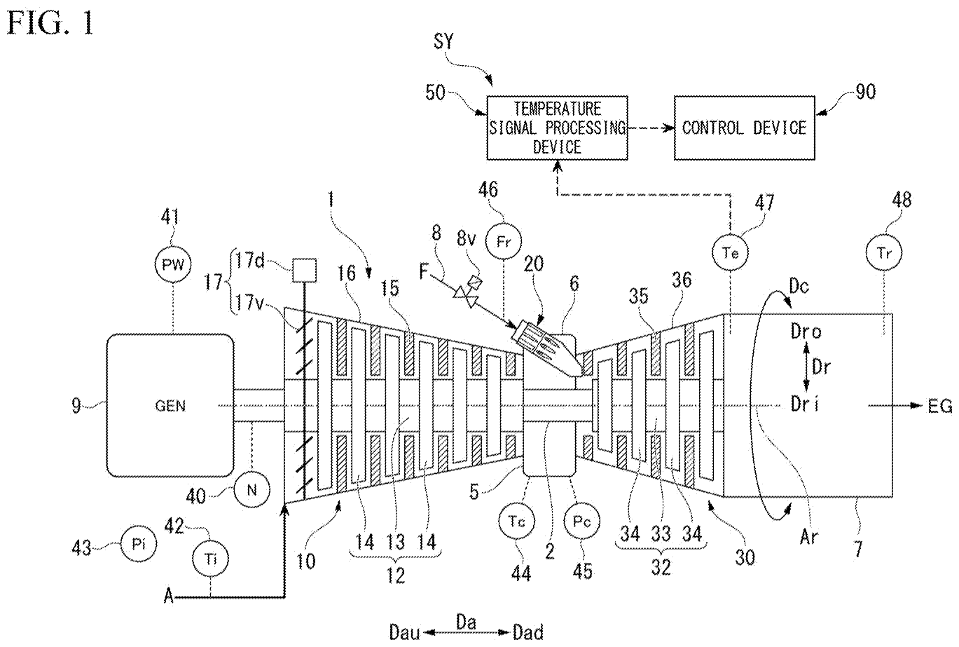

An embodiment of the measurement target of the temperature measurement system according to the present invention and a facility including the measurement target will be described with reference to FIG. 1.

As shown in FIG. 1, the measurement target in the present embodiment is a gas turbine. Therefore, a facility including the measurement target in the present embodiment is a gas turbine facility. The gas turbine 1 includes a compressor 10 configured to compress air A and generate the compressed air, a plurality of combustors 20 configured to burn fuel F in the compressed air and generate combustion gas, a turbine 30 driven by the combustion gas having a high temperature and pressure, and an exhaust casing 7 through which exhaust gas EG, which is combustion gas exhausted from the turbine 30, flows.

The compressor 10 includes a compressor rotor 12 capable of rotating around an axis Ar, a compressor casing 16 configured to cover the compressor rotor 12, a plurality of vane arrays 15, and a suction amount adjuster (hereinafter referred to as an inlet guide vane (IGV)) 17. The turbine 30 includes a turbine rotor 32 capable of rotating around the axis Ar, a turbine casing 36 configured to cover the turbine rotor 32, and a plurality of vane arrays 35. Hereinafter, a direction in which the axis Ar extends is defined as an axial direction Da, the circumferential direction centered on the axis Ar is simply defined as a circumferential direction Dc, and a direction perpendicular to the axis Ar is defined as a radial direction Dr. Also, one side of the axial direction Da is an upstream axial side Dau and the other side is a downstream axial side Dad. Also, a side close to the axis Ar in the radial direction Dr is defined as a radial inner side Dri and the opposite side thereof is defined as a radial outer side Dro.

The compressor 10 is disposed on the upstream axial side Dau with respect to the turbine 30. Also, the exhaust casing 7 is disposed on the downstream axial side Dad with respect to the turbine 30.

The compressor rotor 12 and the turbine rotor 32 are located on the same axis Ar and are connected to each other to form the gas turbine rotor 2. A rotor of the power generator 9 is connected to the gas turbine rotor 2. The power generator 9 functions as an electric motor when the gas turbine 1 starts. An output meter 41 configured to detect electric power generated by the power generator 9 is connected to the power generator 9 or a power line connected to the power generator 9.

The gas turbine 1 further includes an intermediate casing 6. The intermediate casing 6 is disposed between the compressor casing 16 and the turbine casing 36 in the axial direction Da. The exhaust casing 7 is connected to an end of the downstream axial side Dad of the turbine casing 36. The compressor casing 16, the intermediate casing 6, the turbine casing 36, and the exhaust casing 7 are connected to each other and form the gas turbine casing 5.

The compressor rotor 12 includes a rotor shaft 13 extending in the axial direction Da centered on the axis Ar and a plurality of blade arrays 14 attached to the rotor shaft 13. The plurality of blade arrays 14 are arranged in the axial direction Da. Each blade array 14 is composed of a plurality of blades arranged in the circumferential direction Dc. One of the plurality of vane arrays 15 is disposed on the downstream axial side Dad of each of the plurality of blade arrays 14. Each vane array 15 is provided inside of the compressor casing 16. Each vane array 15 is composed of a plurality of vanes arranged in the circumferential direction Dc. The IGV 17 includes a plurality of vanes 17v provided in a suction port of the compressor casing 16 and a drive 17d configured to drive the plurality of vanes 17v. The IGV 17 can adjust the suction amount, which is the flow rate of air suctioned into the compressor casing 16, by causing the drive 17d to open and close the plurality of vanes 17v.

The turbine rotor 32 includes a rotor shaft 33 extending in the axial direction Da centered on the axis Ar and a plurality of blade arrays 34 attached to the rotor shaft 33. The plurality of blade arrays 34 are arranged in the axial direction Da. Each blade array 34 is composed of a plurality of blades arranged in the circumferential direction Dc. One of the plurality of vane arrays 35 is disposed on the upstream axial side Dau of each of the plurality of blade arrays 34. Each vane array 35 is provided inside of the turbine casing 36. Each vane array 35 is composed of a plurality of vanes arranged in the circumferential direction Dc.

The plurality of combustors 20 are arranged in the circumferential direction Dc and attached to the intermediate casing 6. A fuel line 8 capable of guiding fuel F from the fuel supply source to the combustor 20 is connected to the combustor 20. A fuel valve 8V is provided on the fuel line 8.

In addition to the gas turbine 1 described above, the gas turbine facility includes a plurality of measurement devices, a temperature signal processing device 50, and a control device 90.

The gas turbine facility includes a tachometer 40, an output meter 41, an intake air temperature meter 42, an intake air pressure meter 43, a plurality of casing temperature meters 44, an internal casing pressure meter 45, a fuel flow rate meter 46, a plurality of upstream-side exhaust gas temperature meters 47, and a plurality of downstream-side exhaust gas temperature meters 48 as a plurality of measurement devices. The tachometer 40 measures a rotational speed N of the gas turbine rotor 2. The output meter 41 measures an output PW of the power generator 9 as a gas turbine output. The intake air temperature meter 42 measures an intake air temperature Ti, which is the temperature of the air A suctioned by the compressor 10. The intake air pressure meter 43 measures intake air pressure (atmospheric pressure) Pi, which is the pressure of the air A suctioned by the compressor 10. The plurality of casing temperature meters 44 are arranged in the circumferential direction Dc and attached to the intermediate casing 6. The plurality of casing temperature meters 44 measure a temperature Tc within the intermediate casing 6. The internal casing pressure meter 45 measures pressure Pc of the intermediate casing 6. The fuel flow rate meter 46 measures a flow rate Fr of fuel flowing into the combustor 20. The fuel flow rate meter 46 is provided on the fuel line 8. A plurality of upstream-side exhaust gas temperature meters 47 are attached to the exhaust casing 7 arranged in the circumferential direction Dc. The plurality of upstream-side exhaust gas temperature meters 47 measure an upstream-side exhaust gas temperature Te which is the temperature of the exhaust gas EG exhausted from the turbine 30 and flowing into the exhaust casing 7. The plurality of downstream-side exhaust gas temperature meters 48 are attached to the exhaust casing 7 in the circumferential direction Dc at a position on the downstream axial side Dad of the plurality of upstream-side exhaust gas temperature meters 47. The plurality of downstream-side exhaust gas temperature meters 48 measure the downstream-side exhaust gas temperature Tr, which is the temperature of the exhaust gas EG flowing into the exhaust casing 7. Also, the downstream-side exhaust gas temperature Tr is the exhaust gas temperature at the position on the downstream axial side Dad rather than the position where the upstream-side exhaust gas temperature Te is measured.

The control device 90 controls an opening degree of the fuel valve 8v, a drive amount of the IGV 17, an operation of the power generator 9 that functions as an electric motor when the gas turbine 1 is started, and the like in accordance with data from the plurality of measurement devices described above, a requested output from the outside, and the like.

When the number of combustors 20 is, for example, 16, the number of upstream-side exhaust gas temperature meters 47 is, for example, 16, which is substantially the same as the number of combustors 20. Values detected by the plurality of upstream-side exhaust gas temperature meters 47 are used, for example, for the control device 90 to ascertain a failure of the combustor 20 or the like. Also, when the number of combustors 20 is, for example, 16, the number of downstream-side exhaust gas temperature meters 48 is, for example, 8. The value detected by the downstream-side exhaust gas temperature meter 48 is used by the control device 90 to ascertain the possibility of thermal damage to the exhaust casing 7 and the like. The number of casing temperature meters 44 is, for example, 4. The values detected by the plurality of casing temperature meters 44 are used, for example, for the control device 90 to obtain a heat balance of the gas turbine 1 and the like. Also, the values detected by the plurality of casing temperature meters 44 are used by the control device 90 to ascertain the temperature distribution within the intermediate casing 6 after the fuel supply to the combustor 20 is stopped.

The temperature signal processing device 50 inputs signals from the plurality of upstream-side exhaust gas temperature meters 47 and sends only some of these signals to the control device 90.

Both the temperature signal processing device 50 and the control device 90 are configured by a computer. For this reason, the temperature signal processing device 50 and the control device 90 may be configured with one computer or may be configured with separate computers.

The compressor 10 compresses the air A and generates the compressed air and discharges the compressed air into the intermediate casing 6. The compressed air within the intermediate casing 6 flows into the combustor 20. The fuel F is supplied to the combustor 20. The combustor 20 burns fuel F in compressed air and generates combustion gas having a high temperature and pressure. This combustion gas is sent from the combustor 20 into the turbine casing 36. The combustion gas causes the turbine rotor 32 to rotate in a process in which it flows into the turbine casing 36 toward the downstream axial side Dad. In the rotation of the turbine rotor 32, the rotor of the power generator 9 connected to the gas turbine rotor 2 rotates. As a result, the power generator 9 generates power. The exhaust gas EG, which is a combustion gas passing through the last stage blade array of the turbine 30, flows into the exhaust casing 7. This exhaust gas EG is exhausted from the chimney, for example, after flowing into an exhaust heat recovery boiler.

### “Embodiment of Temperature Measurement System”

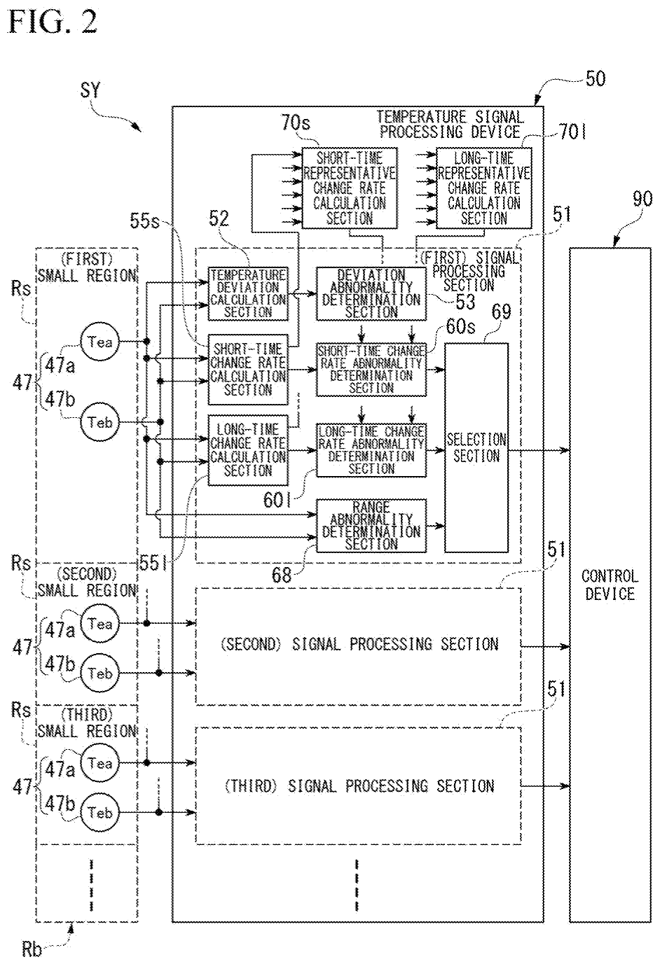

An embodiment of the temperature measurement system according to the present invention will be described with reference to FIGS. 2 to 7.

As shown in FIG. 2, the temperature measurement system SY in the present embodiment includes the plurality of upstream-side exhaust gas temperature meters 47 and the temperature signal processing devices 50 described above.

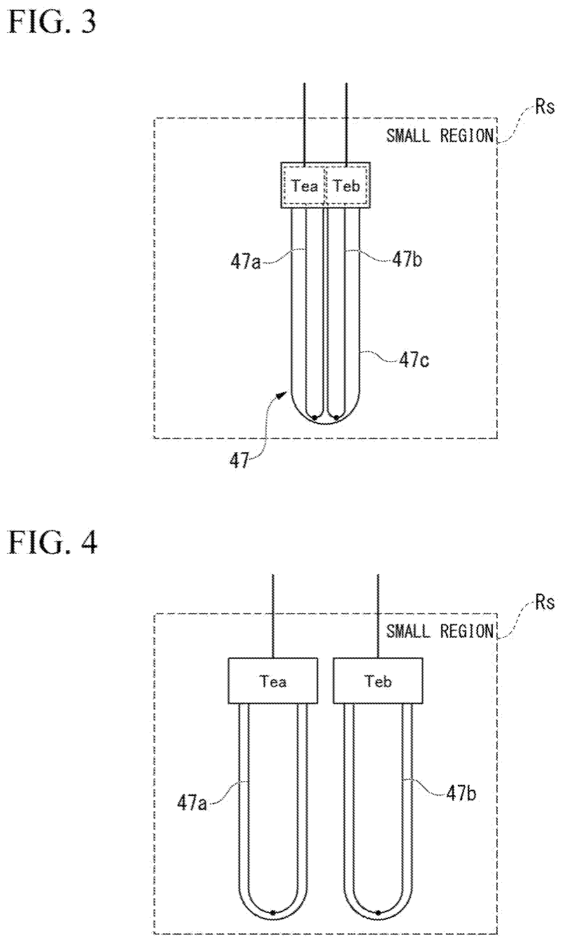

The plurality of upstream-side exhaust gas temperature meters 47 measure the temperature in the space of the upstream axial side Dau within the exhaust casing 7. This space is an annular large region Rb centered on the axis Ar. The normal temperature range is predetermined for this large region Rb. As described above, when the number of combustors 20 is, for example, 16, each of 16 regions into which this large region Rb is divided is a small region Rs. One upstream-side exhaust gas temperature meter 47 is disposed in one small region Rs. One upstream-side exhaust gas temperature meter 47 has a first temperature measurement section 47a and a second temperature measurement section 47b that measure the temperature in the small region Rs, as shown in FIGS. 2 and 3. In the upstream-side exhaust gas temperature meter 47 in the present embodiment, two thermocouples, each of which functions as a temperature measurement section, are disposed within one sheath tube 47c. Consequently, the upstream-side exhaust gas temperature meter 47 in the present embodiment is a double-element type thermocouple.

Because it is only necessary to dispose the first temperature measurement section 47a and the second temperature measurement section 47b in one small region Rs in the temperature measurement system SY in the present embodiment, two single-element thermocouples in which one thermocouple is housed in one sheath tube may be disposed in one small region Rs and the single-element type thermocouples may be designated as the first temperature measurement section 47a and the second temperature measurement section 47b as shown in FIG. 4. Also, three temperature measurement sections are housed in one sheath tube, and one of the three temperature measurement sections may be designated as the first temperature measurement section 47a, another temperature measurement section may be designated as the second temperature measurement section 47b, and the remaining temperature measurement section may be reserved.

The temperature signal processing device 50 sends only a temperature signal from one temperature measurement section between temperature signals from the first temperature measurement section 47a and the second temperature measurement section 47b for each of the plurality of small regions Rs to the control device 90. As shown in FIG. 2, the temperature signal processing device 50 includes a signal processing section 51 located for each of the plurality of small regions Rs, a short-time representative change rate calculation section 70s, and a long-time representative change rate calculation section 70l as functional components.

As described above, the temperature signal processing device 50 includes a computer. Thus, the signal processing section 51, the short-time representative change rate calculation section 70s, and the long-time representative change rate calculation section 70l for each of the plurality of small regions Rs as the functional components function when a central processing unit (CPU) loads a temperature signal processing program stored in an auxiliary storage device such as a hard disk into a main storage device such as a memory and executes the program.

Temperature signals from the first temperature measurement section 47a and the second temperature measurement section 47b disposed within one small region Rs are input to one signal processing section 51. The signal processing section 51 includes a temperature deviation calculation section 52, a deviation abnormality determination section 53, a short-time change rate calculation section 55s, a long-time change rate calculation section 55l, a short-time change rate abnormality determination section 60s, a long-time change rate abnormality determination section 60l, a range abnormality determination section 68, and a selection section 69.

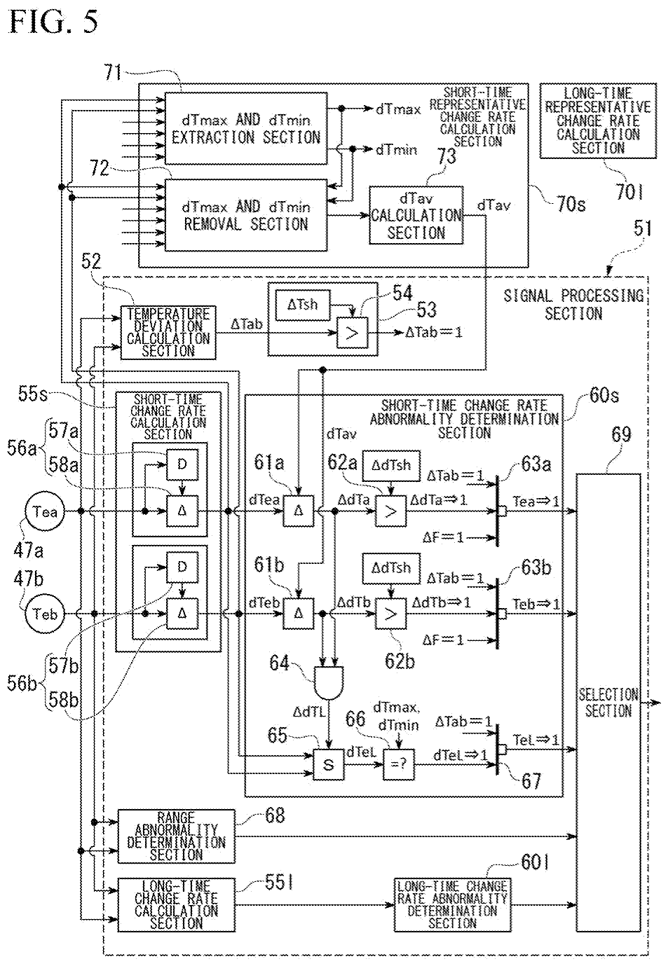

As shown in FIGS. 2 and 5, the temperature deviation calculation section 52 obtains a temperature deviation ΔTab which is the difference between the first measured temperature Tea, which is the temperature measured by the first temperature measurement section 47a, and the second measured temperature Teb, which is the temperature measured by the second temperature measurement section 47b. The first measured temperature Tea and the second measured temperature Teb may be instantaneous values or moving average values for a prescribed period of time (for example, 1 sec).

The deviation abnormality determination section 53 has a magnitude comparator 54 configured to perform a magnitude comparison process for an absolute value of the temperature deviation ΔTab obtained by the temperature deviation calculation section 52 and the predetermined temperature deviation threshold value ΔTsh. When the absolute value of the temperature deviation ΔTab exceeds the temperature deviation threshold value ΔTsh, the magnitude comparator 54 determines that the temperature deviation ΔTab is abnormal and outputs “1” indicating that the temperature deviation ΔTab is abnormal.

The short-time change rate calculation section 55s includes a short-time first temperature change rate calculation section 56a configured to obtain a short-time first temperature change rate dTea, which is the change rate of the first measured temperature Tea per short unit time, and a short-time second temperature change rate calculation section 56b configured to obtain a short-time second temperature change rate dTeb, which is the change rate of the second measured temperature Teb per short unit time. The short-time first temperature change rate calculation section 56a includes a delay device 57a configured to output the first measured temperature Tea from the first temperature measurement section 47a after a delay by a short unit time and a differential device 58a configured to obtain the short-time first temperature change rate dTea which is the difference between the first measured temperature Tea from the first temperature measurement section 47a and the first measured temperature Tea from the delay device 57a. The short-time second temperature change rate calculation section 56b includes a delay device 57b configured to output the second measured temperature Teb from the second temperature measurement section 47b after a delay by a short unit time and a differential device 58b configured to obtain a short-time second temperature change rate dTeb that is a difference between the second measured temperature Teb from the second temperature measurement section 47b and the second measured temperature Teb from the delay device 57b.

The configuration of the long-time change rate calculation section 55l is the same as the configuration of the short-time change rate calculation section 55s. Therefore, description of the configuration of the long-time change rate calculation section 55l will be omitted. Here, the long-time change rate calculation section 55l obtains a long-time first temperature change rate, which is the first temperature change rate per long unit time longer than the short unit time, and a long-time second temperature change rate, which is the second temperature change rate per long unit time.

Here, the short unit time is, for example, 1 sec, and the long unit time is, for example, 10 sec. Also, the change rate may be a difference between the instantaneous values of the measured temperatures measured at different times or a difference between the moving averages of the measured temperatures measured in different time periods.

The short-time representative change rate calculation section 70s obtains a short-time representative change rate, which is a value representative of the short-time temperature change rate for each of the plurality of small regions Rs, using the short-time first temperature change rate dTea and the short-time second temperature change rate dTeb for each of the plurality of small regions Rs. All of short-time change rates obtained by short-time change rate calculation sections 55s of the plurality of signal processing sections 51 are input to the short-time representative change rate calculation section 70s. The short-time representative change rate calculation section 70s includes a maximum and minimum change rate extraction section 71, a maximum and minimum change rate removal section 72, and an average change rate calculation section 73. The maximum and minimum change rate extraction section 71 extracts a maximum change rate dTmax and a minimum change rate dTmim from the short-time change rates from the plurality of signal processing sections 51, and outputs the maximum change rate dTmax and the minimum change rate dTmim as a short-time representative change rate. The maximum and minimum change rate removal section 72 excludes the maximum change rate dTmax and the minimum change rate dTmim from the short-time change rates from the plurality of signal processing sections 51. The average change rate calculation section 73 obtains an average change rate dTav, which is the average value of all change rates other than the maximum change rate dTmax and the minimum change rate dTmim, among the short-time change rates from the plurality of signal processing sections 51 and outputs the average change rate dTav as the short-time representative change rate. Also, the average change rate dTav may be the average change rate of all the short-time change rates from the plurality of signal processing sections 51.

The configuration of the long-time representative change rate calculation section 70l is the same as the configuration of the short-time representative change rate calculation section 70s. Therefore, description of the configuration of the long-time representative change rate calculation section 70l will be omitted. Here, the long-time change rates obtained by the long-time change rate calculation sections 55l of the plurality of signal processing sections 51 are input to the long-time representative change rate calculation section 70l. For this reason, the long-time representative change rate calculation section 70l extracts the maximum change rate and the minimum change rate from a plurality of long-time change rates on the basis of the input plurality of long-time change rates and outputs the maximum change rate and the minimum change rate as the long-time representative change rate. Furthermore, the long-time representative change rate calculation section 70l obtains an average change rate that is the average value of all change rates other than the maximum change rate and the minimum change rate among the plurality of long-time change rates, and outputs the average change rate as the long-time representative change rate.

The short-time change rate abnormality determination section 60s determines whether the first measured temperature Tea is abnormal and whether the second measured temperature Teb is abnormal using the short-time first temperature change rate dTea and the short-time second temperature change rate dTeb obtained by the short-time change rate calculation section 55s and the short-time representative change rate obtained by the short-time representative change rate calculation section 70s.

The short-time change rate abnormality determination section 60s includes a first differential device 61a, a first magnitude comparator 62a, a first AND circuit 63a, a second differential device 61b, a second magnitude comparator 62b, a second magnitude comparator 63b, a third magnitude comparator 64, a change rate selector 65, a change rate comparator 66, and a third AND circuit 67.

The first differential device 61a obtains a first change rate deviation ΔdTa, which is the difference between the short-time first temperature change rate dTea and the average change rate dTav, which is one of the short-time representative change rates. The first magnitude comparator 62a performs a magnitude comparison process for an absolute value of the first change rate deviation ΔdTa obtained by the first differential device 61a and a predetermined change rate deviation threshold value ΔdTsh. When the absolute value of the first change rate deviation ΔdTa exceeds the change rate deviation threshold value ΔdTsh, the first magnitude comparator 62a determines that the first change rate deviation ΔdTa is abnormal and outputs “1” indicating that the first change rate deviation ΔdTa is abnormal. The first AND circuit 63a determines that the first measured temperature Tea is abnormal when the temperature deviation ΔTab is abnormal as indicated by “1,” the first change rate deviation ΔdTa is abnormal as indicated by “1,” and a change ΔF in the fuel flow rate is small as indicated by “1” and outputs “I” indicating that the first measured temperature Tea is abnormal. Here, a case where the change ΔF in the fuel flow rate is small is a case where the change ΔF in the flow rate of the fuel supplied to the plurality of combustors 20 is less than a predetermined value. In this case, the control device 90 outputs information indicating that the change ΔF in the fuel flow rate is large to the temperature measurement system SY. The case where the change ΔF in the fuel flow rate is large include the time when the gas turbine 1 is started, the time when the load is cut off from the power generator 9, the time of runback for the power generator 9 (the time of high-speed load reduction control), the time when the gas turbine 1 is stopped, and the like. When the temperature signal processing device 50 does not receive information indicating that the change ΔF in the fuel flow rate is large from the control device 90, the change ΔF in the fuel flow rate is small as indicated by “1.”

The second differential device 61b obtains a second change rate deviation ΔdTb, which is the difference between the short-time second temperature change rate dTeb and the average change rate dTav, which is one of the short-time representative change rates. The second magnitude comparator 62b performs a magnitude comparison process for an absolute value of the second change rate deviation ΔdTb obtained by the second differential device 61b and the predetermined change rate deviation threshold value ΔdTsh. When the absolute value of the second change rate deviation ΔdTb exceeds the change rate deviation threshold value ΔdTsh, the second magnitude comparator 62b determines that the second change rate deviation ΔdTb is abnormal and outputs “I” indicating that the second change rate deviation ΔdTb is abnormal. The second AND circuit 63b determines that the second measured temperature Teb is abnormal when the temperature deviation ΔTab is abnormal as indicated by “1,” the second change rate deviation ΔdTb is abnormal as indicated by “1” and the change ΔF in fuel flow rate is small as indicated by “1”, and outputs “1” indicating that the second measured temperature Teb is abnormal.

The third magnitude comparator 64 performs a magnitude comparison process for the absolute value of the first change rate deviation ΔdTa obtained by the first differential device 61a and the absolute value of the second change rate deviation ΔdTb obtained by the second differential device 61b and outputs a larger change rate deviation ΔdTL (=ΔdTa or ΔdTb). The change rate selector 65 outputs a temperature change rate dTeL corresponding to the larger change rate deviation ΔdTL between the short-time first temperature change rate dTea and the short-time second temperature change rate dTeb. The change rate comparator 66 determines whether or not the temperature change rate dTeL (=dTea or dTeb) output by the change rate selector 65 is equal to the maximum change rate dTmax or the minimum change rate dTmim obtained by the short-time representative change rate calculation section 70s. When the temperature change rate dTeL output by the change rate selector 65 is equal to the maximum change rate dTmax or the minimum change rate dTmim, the change rate comparator 66 outputs “I” indicating that the temperature change rate dTeL (=dTea or dTeb) is abnormal. The third AND circuit 67 outputs “1” indicating that the measured temperature TeL (=Tea or Teb) relating to the temperature change rate dTeL (=dTea or dTeb) is abnormal when the temperature deviation ΔTab is abnormal as indicated by “1” and the temperature change rate dTeL (=dTea or dTeb) having a larger change rate deviation ΔdTL (=ΔdTa or ΔdTb) is abnormal as indicated by “1.”

The long-time change rate abnormality determination section 60l determines whether the first measured temperature Tea is abnormal and whether the second measured temperature Teb is abnormal using the long-time first temperature change rate and the long-time second temperature change rate obtained by the long-time change rate calculation section 55l and the long-time representative change rate obtained by the long-time representative change rate calculation section 70l.

The configuration of the long-time change rate abnormality determination section 60l is the same as the configuration of the short-time change rate abnormality determination section 60s. Therefore, description of the configuration of the long-time change rate abnormality determination section 60l will be omitted. Like the short-time change rate abnormality determination section 60s, the long-time change rate abnormality determination section 60l also includes a first differential device, a first magnitude comparator, a first AND circuit, a second differential device, a second magnitude comparator, a second AND circuit, a third magnitude comparator, a change rate selector, a change rate comparator, and a third AND circuit. Here, the long-time first temperature change rate and the long-time second temperature change rate obtained by the long-time change rate calculation section 55l are input to the long-time change rate abnormality determination section 60l. Thus, when the temperature deviation Tab is abnormal, the long-time first change rate deviation is abnormal, and the change in the fuel flow rate is small, the first AND circuit of the long-time change rate abnormality determination section 60l determines that the first measured temperature Tea is abnormal and outputs “1” indicating that the first measured temperature Tea is abnormal. Also, when the temperature deviation ΔTab is abnormal, the long-time second change rate deviation is abnormal, and the change in the fuel flow rate is small, the second AND circuit of the long-time change rate abnormality determination section 60l determines that the second measured temperature Teb is abnormal and outputs “1” indicating that the second measured temperature Teb is abnormal. Also, the third AND circuit of the long-time change rate abnormality determination section 60l outputs “1” indicating that the measured temperature TeL (=Tea or Teb) having a large long-time change rate deviation is abnormal when the temperature deviation ΔTab is abnormal and a long-time temperature change rate having a large long-time change rate deviation is abnormal.

The range abnormality determination section 68 determines whether or not the first measured temperature Tea is abnormal in accordance with whether or not the first measured temperature Tea is within a normal temperature range predetermined for the large region Rb. Furthermore, the range abnormality determination section 68 determines whether or not the second measured temperature Teb is abnormal in accordance with whether or not the second measured temperature Teb is within a normal temperature range predetermined for the large region Rb. The range abnormality determination section 68 determines that the first measured temperature Tea is abnormal when the first measured temperature Tea is not within the normal temperature range and determines that the second measured temperature Teb is abnormal when the second measured temperature Teb is not within the normal temperature range.

Here, in the short-time change rate abnormality determination section 60s, the long-time change rate abnormality determination section 60l, and the range abnormality determination section 68 in one signal processing section 51, the first measured temperature Tea of the determination target is the target first measured temperature Tea input to one signal processing section 51 and the second measured temperature Teb of the determination target is the target second measured temperature Teb input to the one signal processing section 51. Here, an abnormality in the first measured temperature Tea is an abnormality in the first temperature measurement section 47a and an abnormality in the second measured temperature Teb is an abnormality in the second temperature measurement section 47b.

The selection section 69 sends the temperature measured by the temperature measurement section determined not to be abnormal between the first temperature measurement section 47a and the second temperature measurement section 47b to the control device 90.

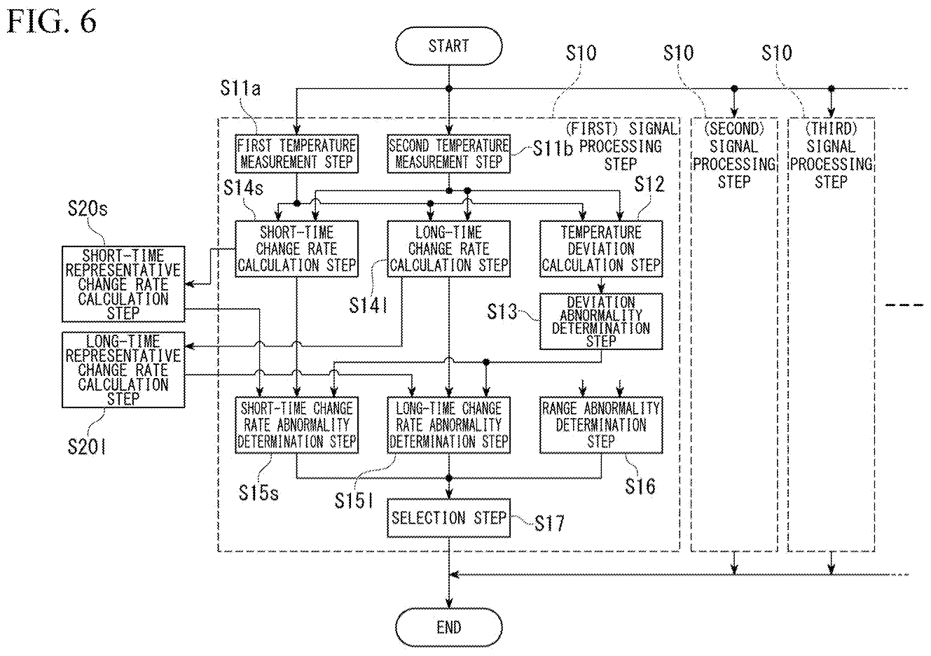

Next, an operation of the temperature measurement system SY will be described in accordance with the flowchart shown in FIG. 6.

The temperature measurement system SY executes a signal processing step S10, a short-time representative change rate calculation step S20s, and a long-time representative change rate calculation step S201 to be performed for each of the plurality of small regions Rs.

The signal processing step S10 for each of the plurality of small regions Rs includes a first temperature measurement step S11a, a second temperature measurement step S11b, a temperature deviation calculation step S12, a deviation abnormality determination step S13, a short-time change rate calculation step S14s, a long-time change rate calculation step S14l, a short-time change rate abnormality determination step S15s, a long-time change rate abnormality determination step S15l, a range abnormality determination step S16, and a selection step S17.

In the first temperature measurement step S11a, the temperature of the small region Rs handled in the signal processing step S10 is measured by the first temperature measurement section 47a disposed in the small region Rs. In the second temperature measurement step S11b, the temperature of the small region Rs handled in the signal processing step S10 is measured by the second temperature measurement section 47b disposed in the small region Rs. The temperature measured in the first temperature measurement step S11a in the signal processing step S10 is the target first measured temperature Tea and the temperature measured by the second temperature measurement step S11b in the signal processing step S10 is the target second measured temperature Teb.

In the temperature deviation calculation step S12, the temperature deviation calculation section 52 obtains the temperature deviation ΔTab, which is the difference between the target first measured temperature Tea and the target second measured temperature Teb.

In the deviation abnormality determination step S13, the deviation abnormality determination section 53 performs a magnitude comparison process for the absolute value of the temperature deviation ΔTab and the predetermined temperature deviation threshold value ΔTsh. Also, in this deviation abnormality determination step S13, when the absolute value of the temperature deviation ΔTab exceeds the temperature deviation threshold value ΔTsh, the temperature deviation ΔTab is determined to be abnormal and “1” indicating that the temperature deviation ΔTab is abnormal is output.

In the short-time change rate calculation step S14s, the short-time change rate calculation section 55s obtains a short-time first temperature change rate dTea, which is the change rate of the target first measured temperature Tea per short unit time and a short-time second temperature change rate dTeb, which is the change rate of the target second measured temperature Teb per short unit time.

In the long-time change rate calculation step S14l, the long-time change rate calculation section 55l obtains a long-time first temperature change rate, which is the change rate of the target first measured temperature Tea per long unit time, and a long-time second temperature change rate, which is the change rate of the target second measured temperature Teb per long unit time.

In the short-time representative change rate calculation step S20s, the short-time representative change rate calculation section 70s extracts the maximum change rate dTmax and the minimum change rate dTmim from the short-time first temperature change rate dTea and the long-time second temperature change rate dTeb obtained in the short-time change rate calculation step S14s for each of the plurality of signal processing steps S10 and outputs the maximum change rate dTmax and the minimum change rate dTmim as the short-time representative change rate. In the short-time representative change rate calculation step S20s, the short-time representative change rate calculation section 70s further obtains an average change rate dTav, which is the average value of all change rates other than a maximum change rate dTmax and a minimum change rate dTmim among the short-time first temperature change rates dTea and the short-time second temperature change rates dTeb in the short-time change rate calculation step S14s for each of the plurality of signal processing steps S10 and outputs the average change rate dTav as the short-time representative change rate.

In the long-time representative change rate calculation step S201, the long-time representative change rate calculation section 70l extracts the maximum change rate and the minimum change rate from the long-time change rates obtained in the long-time change rate calculation step S14l for each of the plurality of signal processing steps S10 and outputs the maximum change rate and the minimum change rate as the long-time representative change rate. In the long-time representative change rate calculation step S201, the long-time representative change rate calculation section 70l further obtains an average change rate, which is the average value of all change rates other than a maximum change rate and a minimum change rate among the long-time change rates in the long-time change rate calculation step S14l for each of the plurality of signal processing steps S10 and outputs the average change rate as the long-time representative change rate.

The temperature measurement section measuring the first measured temperature Tea or the second measured temperature Teb indicating the maximum change rate dTmax or the minimum change rate dTmim among the first temperature change rates dTea and the second temperature change rates dTeb for each of the plurality of small regions Rs is likely to be abnormal. Therefore, in the present embodiment, the accuracy of abnormality determination is improved using the average change rate dTav of all change rates other than the maximum change rate dTmax and the minimum change rate dTmim among the first temperature change rates dTea and the second temperature change rates dTeb for each of the plurality of small regions Rs as the average change rate dTav for use in determining whether or not the first temperature measurement section 47a and the second temperature measurement section 47b are abnormal.

In the deviation abnormality determination step S13, when it is determined that the temperature deviation ΔTab between the target first measured temperature Tea and the target second measured temperature Teb is abnormal, one of the first temperature measurement section 47a measuring the target first measured temperature Tea and the second temperature measurement section 47b measuring the target second measured temperature Teb is likely to be abnormal. Thus, in the short-time change rate abnormality determination step S15s and the long-time change rate abnormality determination step S15l, it is determined which of the first temperature measurement section 47a measuring the target first measured temperature Tea and the second temperature measurement section 47b measuring the target second measured temperature Teb is abnormal using the first temperature change rate dTea of the target first measured temperature Tea and the second temperature change rate dTeb of the target second measured temperature Teb.

In the short-time change rate abnormality determination step S15s and the long-time change rate abnormality determination step S15l, it is determined which of the first temperature measurement section 47a measuring the target first measured temperature Tea and the second temperature measurement section 47b measuring the target second measured temperature Teb is abnormal in each of the first determination method and the second determination method. In the first determination method, it is determined which of the first temperature measurement section 47a measuring the target first measured temperature Tea and the second temperature measurement section 47b measuring the target second measured temperature Teb is abnormal on the basis of the change rate deviation ΔdT, which is the difference between the temperature change rate dT and the average change rate dTav. In the second determination method, it is determined which of the first temperature measurement section 47a measuring the target first measured temperature Tea and the second temperature measurement section 47b measuring the target second measured temperature Teb is abnormal on the basis of whether the temperature change rate dT is the maximum change rate dTmax or the minimum change rate dTmim.

In the short-time change rate abnormality determination step S15s, the first differential device 61a of the short-time change rate abnormality determination section 60s obtains the first change rate deviation ΔdTa, which is the difference between the short-time first temperature change rate dTea and the average change rate dTav, which is one of the short-time representative change rates. Furthermore, the second differential device 61b of the short-time change rate abnormality determination section 60s obtains the second change rate deviation ΔdTb, which is the difference between the short-time second temperature change rate dTeb and the average change rate dTav, which is one of the short-time representative change rates.

In the first determination method in the short-time change rate abnormality determination step S15s, the first magnitude comparator 62a of the short-time change rate abnormality determination section 60s performs a magnitude comparison process for the absolute value of the first change rate deviation ΔdTa and the predetermined change rate deviation threshold value ΔdTsh. When the absolute value of the first change rate deviation ΔdTa exceeds the change rate deviation threshold value ΔdTsh, the first magnitude comparator 62a determines that the first change rate deviation ΔdTa is abnormal and outputs “1” indicating that the first change rate deviation ΔdTa is abnormal. The first AND circuit 63a determines that the first measured temperature Tea is abnormal when the temperature deviation ΔTab is abnormal as indicated by “1,” the first change rate deviation ΔdTa is abnormal as indicated by “1.” and a change ΔF in the fuel flow rate is small as indicated by “1” and outputs “1” indicating that the first measured temperature Tea is abnormal.

In the first determination method in the short-time change rate abnormality determination step S15s, the second magnitude comparator 62b of the short-time change rate abnormality determination section 60s further performs a magnitude comparison process for an absolute value of the second change rate deviation ΔdTb and the change rate deviation threshold value ΔdTsh. When the absolute value of the second change rate deviation ΔdTb exceeds the change rate deviation threshold value ΔdTsh, the second magnitude comparator 62b determines that the second change rate deviation ΔdTh is abnormal and outputs “1” indicating that the second change rate deviation ΔdTb is abnormal. The second AND circuit 63b determines that the second measured temperature Teb is abnormal when the temperature deviation ΔTab is abnormal as indicated by “1,” the second change rate deviation ΔdTb is abnormal as indicated by “1,” and the change ΔF in fuel flow rate is small as indicated by “1,” and outputs “1” indicating that the second measured temperature Teb is abnormal.

In the second determination method in the short-time change rate abnormality determination step S15s, the third magnitude comparator 64 of the short-time change rate abnormality determination section 60s performs a magnitude comparison process for the absolute value of the short-time first change rate deviation ΔdTa obtained by the first differential device 61a and the absolute value of the short-time second change rate deviation ΔdTb obtained by the second differential device 61b and outputs a larger change rate deviation ΔdTL (=ΔdTa or ΔdTb). The change rate selector 65 of the short-time change rate abnormality determination section 60s outputs a temperature change rate dTeL corresponding to the larger change rate deviation ΔdTL between the short-time first temperature change rate dTea and the short-time second temperature change rate dTeb. The change rate comparator 66 determines whether or not the temperature change rate dTeL (=dTea or dTeb) output by the change rate selector 65 is equal to the maximum change rate dTmax or the minimum change rate dTmim obtained by the short-time representative change rate calculation section 70s. When the temperature change rate dTeL output by the change rate selector 65 is equal to the maximum change rate dTmax or the minimum change rate dTmim, the change rate comparator 66 outputs “I” indicating that the temperature change rate dTeL (=dTea or dTeb) is abnormal. The third AND circuit 67 outputs “1” indicating that the measured temperature TeL (=Tea or Teb) relating to the temperature change rate dTeL (=dTea or dTeb) is abnormal when the temperature deviation ΔTab is abnormal as indicated by “1” and the temperature change rate dTeL (=dTea or dTeb) having a larger change rate deviation ΔdTL (=,% dTa or ΔdTb) is abnormal as indicated by “1.”

In the long-time change rate abnormality determination step S15l, as in the short-time change rate abnormality determination step S15s, it is determined which of the first temperature measurement section 47a measuring the target first measured temperature Tea and the second temperature measurement section 47b measuring the target second measured temperature Teb is abnormal using the long-time first change rate, the long-time second change rate, and the long-time representative change rate.

In the range abnormality determination step S16, the range abnormality determination section 68 determines whether or not the target first measured temperature Tea is abnormal when the target first measured temperature Tea is not within a normal temperature range predetermined for the large region Rb. Also, in the range abnormality determination step S16, the range abnormality determination section 68 determines that the target second measured temperature Teb is abnormal when the target second measured temperature Teb is not within the normal temperature range predetermined for the large region Rb.

In the selection step S17, the target measured temperature Tea or Teb determined not to be abnormal between the target first measured temperature Tea and the target second measured temperature Teb in the short-time change rate abnormality determination step S15s, the long-time change rate abnormality determination step S15l, and the range abnormality determination step S16 are sent to the control device 90.

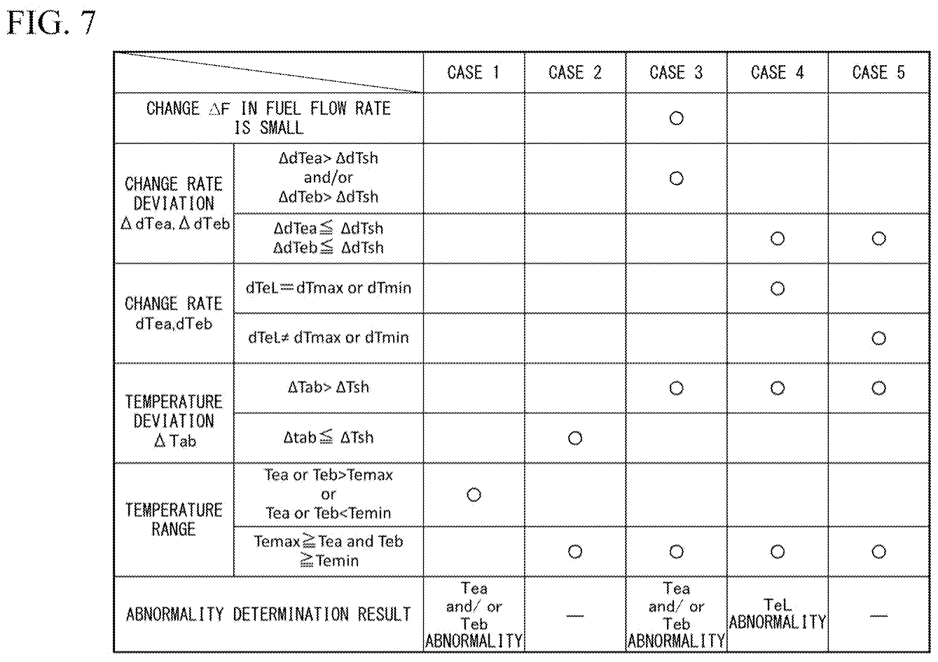

Next, relationships between various types of conditions and the abnormal determination result will be described with reference to FIG. 7. As described above, here as well, an abnormality in the first measured temperature Tea is an abnormality in the first temperature measurement section 47a and an abnormality in the second measured temperature Teb is an abnormality in the second temperature measurement section 47b.

In the present embodiment, there are the following five cases as aspects of various types of conditions.

Case 1 is a case where at least one of the target first measured temperature Tea and the target second measured temperature Teb is not within a normal temperature range predetermined for the large region Rb. In other words, this is a case where at least one of the target first measured temperature Tea and the target second measured temperature Teb exceeds a maximum temperature Temax in the normal temperature range predetermined for the large region Rb or is lower than a minimum temperature Temin in the normal temperature range predetermined for the large region Rb.

In this case, regardless of other conditions, the target measured temperatures Tea and Teb, which are not within the normal temperature range among the target first measured temperatures Tea and the target second measured temperatures Teb, are considered to be abnormal. Also, the abnormality determination in case 1 is performed by the range abnormality determination section 68.

All of cases 2 to 5 are cases where both the target first measured temperature Tea and the target second measured temperature Teb are within the normal temperature range predetermined for the large region Rb. In other words, these cases are cases where both the target first measured temperature Tea and the target second measured temperature Teb are lower than the maximum temperature Temax in the normal temperature range and higher than the minimum temperature Temin in the normal temperature range. Also, the abnormality determination in cases 2 to 5 is performed by each of the short-time change rate abnormality determination section 60s and the long-time change rate abnormality determination section 60l.

Case 2 is a case where the temperature deviation ΔTab between the target first measured temperature Tea and the target second measured temperature Teb is less than or equal to a predetermined temperature deviation threshold value ΔTsh in addition to the above temperature range condition.

In this case, both the target first measured temperature Tea and the target second measured temperature Teb are considered not to be abnormal.

In cases 3 to 5, in addition to the above temperature range condition, the temperature deviation ΔTab between the target first measured temperature Tea and the target second measured temperature Teb may exceed the predetermined temperature deviation threshold value ΔTsh.

In addition to the above temperature range condition and the above temperature deviation condition, case 3 is a case where the first change rate deviation ΔdTa between the first temperature change rate dTea and the average change rate dTav is greater than the predetermined change rate deviation threshold value ΔdTsh and/or the second change rate deviation ΔdTb between the second temperature change rate dTeb and the average change rate dTav is greater than the change rate deviation threshold value ΔdTsh and is a case where the change ΔF in the fuel flow rate is small.

In this case, it is considered that the target measured temperatures Tea and Teb for which the change rate deviation is greater than the change rate deviation threshold value ΔdTsh are abnormal. That is, the target first measured temperature Tea is considered to be abnormal when the first change rate deviation ΔdTa is greater than the change rate deviation threshold value ΔdTsh and the target second measured temperature Teb is considered to be abnormal when the second change rate deviation ΔdTb is greater than the change rate deviation threshold value ΔdTsh.

Therefore, in addition to the above temperature range condition and the above temperature deviation condition, the target measured temperatures Tea and Teb having a large change rate deviation are considered not to be abnormal when the change ΔF in fuel flow rate is large even if the first change rate deviation ΔdTa between the first temperature change rate dTea and the average change rate dTav is greater than the change rate deviation threshold value ΔdTsh and/or the second change rate deviation ΔdTb between the second temperature change rate dTeb and the average change rate dTav is greater than the change rate deviation threshold value ΔdTsh.

Also, in cases 1, 2, 4, and 5 other than case 3, the magnitude of the change ΔF in the fuel flow rate does not affect the abnormality determination. When the change ΔF in the fuel flow rate is large, the change rate deviation ΔdT between the temperature change rate dT and the average change rate dTav is larger than when the change ΔF in the fuel flow rate is small. For this reason, when the change ΔF in the fuel flow rate is large, even if the temperature measurement sections measuring the target measured temperatures Tea and Teb are normal, the change rate deviation ΔdT becomes larger than the predetermined change rate deviation threshold value ΔdTsh and the temperature measurement section may be determined to be abnormal. Therefore, in the present embodiment, in order to improve the accuracy of the abnormality determination, as in case 3, a condition that the change ΔF in the fuel flow rate is small only when the target measured temperatures Tea and Teb having a large change rate deviation ΔdT are determined to be abnormal is given. In other words, in the present embodiment, when the change ΔF in fuel flow rate is large, even if the change rate deviation ΔdT exceeds the change rate deviation threshold value ΔdTsh, the temperature measurement sections measuring the target measured temperatures Tea and Teb is determined not to be abnormal.

Cases 4 and 5 are cases where the first change rate deviation ΔdTa between the first temperature change rate dTea and the average change rate dTav and the second change rate deviation ΔdTb between the second temperature change rate dTeb and the average change rate dTav are less than or equal to the predetermined the change rate deviation threshold value ΔdTsh in addition to the above temperature range condition and the above temperature deviation condition.

Case 4 is a case where the temperature change rate dTeL (=dTea or dTeb) corresponding to a larger change rate deviation ΔdTL between the absolute value of the first change rate deviation ΔdTa and the absolute value of the second change rate deviation ΔdTb is equal to the maximum change rate dTmax or the minimum change rate dTmim in addition to the above temperature range condition, the above temperature deviation condition, and the above change rate deviation condition.

In this case, the target measured temperature TeL (=Tea or Teb) having a larger change rate deviation ΔdTL between the target first measured temperature Tea and the target second measured temperature Teb is considered to be abnormal.

Case 5 is a case where the temperature change rate dTeL (=dTea or dTeb) corresponding to a larger change rate deviation ΔdTL between the absolute value of the first change rate deviation ΔdTa and the absolute value of the second change rate deviation ΔdTb is not equal to the maximum change rate dTmax or the minimum change rate dTmim in addition to the above temperature range condition, the above temperature deviation condition, and the above change rate deviation condition.

In this case, both the target first measured temperature Tea and the target second measured temperature Teb are considered not to be abnormal.

As described above, in the present embodiment, it is determined whether or not the temperature deviation ΔTab, which is the difference between the first measured temperature Tea, which is the temperature measured by the first temperature measurement section 47a disposed in one small region Rs, and the second measured temperature Teb, which is the temperature measured by the second temperature measurement section 47b disposed in the small region Rs, exceeds the predetermined temperature deviation threshold value ΔTsh. When the temperature deviation ΔTab exceeds the temperature deviation threshold value ΔTsh, at least one temperature measurement section between the first temperature measurement section 47a and the second temperature measurement section 47b is likely to be abnormal. In this case, in the present embodiment, the first temperature change rate dTea relating to the target first measured temperature Tea, which is the first measured temperature Tea used in the calculation of the abnormality deviation, which is the temperature deviation ΔTab exceeding the temperature deviation threshold value ΔTsh, is compared with the representative change rate obtained using the first temperature change rate dTea and the second temperature change rate dTeb for each of the plurality of small regions Rs. In the present embodiment, furthermore, the representative change rate is compared with the second temperature change rate dTeb relating to the target second measured temperature Teb, which is the second measured temperature Teb used in the calculation of the abnormality deviation. Also, in the present embodiment, the change rate abnormality determination sections 60s and 60l determine whether or not the first temperature measurement section 47a measuring the target first measured temperature Tea is abnormal and whether or not the second temperature measurement section 47b measuring the target second measured temperature Teb is abnormal from these comparison results.

If the type of the temperature measurement section and the failure location in the temperature measurement section are different, the response time from the time when the temperature change in the small region Rs occurs to the time when the measured temperatures Tea and Teb output from the temperature measurement sections change may change. Therefore, in the present embodiment, the accuracy of the abnormality determination is improved by determining the abnormality of the temperature measurement section on the basis of the temperature change rate per unit time relating to two types of unit time that are different from each other.

The temperature signal processing device 50 of the present embodiment sends the temperature measured by the temperature measurement section determined not to be abnormal to the control device 90. Thus, the occurrence of a malfunction of gas turbine control of the control device 9) can be suppressed.

### “Modified Examples”

The representative change rates in the above embodiment are the maximum change rate dTmax and the minimum change rate dTmim among the first measured temperatures Tea and the second measured temperatures Teb for each of the plurality of small regions Rs and the average change rate dTav obtained from the first measured temperature Tea and the second measured temperature Teb for each of the plurality of small regions Rs. However, the representative change rate may be only one of the maximum change rate dTmax, the minimum change rate dTmim, and the average change rate dTav. In this case, the short-time change rate abnormality determination section 60s and the long-time change rate abnormality determination section 60l determine only either the abnormality determination based on whether the temperature change rate is the minimum change rate dTmim or the maximum change rate dTmax or the abnormality determination based on a deviation between the temperature change rate and the average change rate dTav.

In the short-time change rate abnormality determination section 60s and the long-time change rate abnormality determination section 60l in the above embodiment, when the temperature deviation ΔTab is abnormal, the change rate deviation ΔdT is abnormal, and the change in the fuel flow rate, which is a parameter serving as the cause of the temperature change in the large region Rb, is small, the measured temperatures Tea and Teb are determined to be abnormal. However, the change in the fuel flow rate as the parameter may be excluded from the condition for the abnormality determination.

The temperature measurement system SY in the above embodiment includes the selection section 69 configured to send the temperature measured by the temperature measurement section determined not to be abnormal between the first temperature measurement section 47a and the second temperature measurement section 47b to the control device 90. However, the selection section 69 may be omitted. In this case, if the temperature measurement system SY determines that either the first temperature measurement section 47a or the second temperature measurement section 47b is abnormal, it is only necessary to externally output a determination result.

The temperature measurement system SY of the above embodiment has a plurality of upstream-side exhaust gas temperature meters 47. However, the temperature measurement system SY may have a plurality of downstream-side exhaust gas temperature meters 48 and a plurality of casing temperature meters 44 instead of the plurality of upstream-side exhaust gas temperature meters 47.

If the temperature measurement system SY has the plurality of downstream-side exhaust gas temperature meters 48, an annular space of the downstream axial side Dad within the exhaust casing 7 becomes the large region Rb, and each of regions into which the large region Rb is divided in the circumferential direction Dc is a small region Rs. In one small region Rs, a first temperature measurement section and a second temperature measurement section are disposed. Also, in this case, the parameter serving as the cause of the temperature change in the large region Rb is the fuel flow rate.

Also, if the temperature measurement system SY has a plurality of casing temperature meters 44, the annular space within the intermediate casing 6 becomes the large region Rb and each of regions into which the large region Rb is divided in the circumferential direction Dc is the small region Rs. In one small region Rs, a first temperature measurement section and a second temperature measurement section are disposed. Also, in this case, the parameter causing the temperature change in the large region Rb is, for example, a cooling air flow rate supplied into the intermediate casing 6 after stopping the gas turbine 1.

The measurement target in the above embodiment is the gas turbine 1. However, the measurement target is not limited to the gas turbine 1.

The present disclosure is not limited to the embodiments and the modified examples described above. Various additions, changes, replacements, partial deletions, and the like are possible without departing from the conceptual idea and spirit of the present invention derived from content described in the claims and equivalents thereof.

### “Appendix”

The temperature measurement system SY in the above-described embodiment is ascertained, for example, as follows.

(1) According to a first aspect, there is provided a temperature measurement system SY including: first and second temperature measurement sections 47a and 47b provided for each of a plurality of small regions Rs into which a large region Rb where a normal temperature range is predetermined is divided in a measurement target and configured to measure a temperature within the small region Rs; a temperature deviation calculation section 52 provided for each of the plurality of small regions Rs and configured to obtain a temperature deviation ΔTab, which is the difference between a first measured temperature Tea, which is a temperature measured by the first temperature measurement section 47a, and a second measured temperature Teb, which is a temperature measured by the second temperature measurement section 47b; a deviation abnormality determination section 53 provided for each of the plurality of small regions Rs and configured to determine whether or not the temperature deviation ΔTab exceeds a predetermined temperature deviation threshold value ΔTsh; change rate calculation sections 55s and 55l provided for each of the plurality of small regions Rs and configured to obtain a first temperature change rate dTea, which is the change rate per unit time in the first measured temperature Tea, and a second temperature change rate dTeb, which is the change rate per unit time in the second measured temperature Teb; representative change rate calculation sections 70s and 70l configured to obtain a representative change rate, which is a value representative of the temperature change rate for each of the plurality of small regions Rs, using the first temperature change rate dTea and the second temperature change rate dTeb for each of the plurality of small regions Rs; and change rate abnormality determination sections 60s and 60l provided for each of the plurality of small regions Rs and configured to compare the representative change rate with the first temperature change rate dTea relating to a target first measured temperature Tea, which is the first measured temperature Tea used in calculation of an abnormality deviation, which is the temperature deviation ΔTab exceeding the temperature deviation threshold value ΔTsh, when the temperature deviation ΔTab exceeds the temperature deviation threshold value ΔTsh, compare the representative change rate with the second temperature change rate dTeb relating to a target second measured temperature Teb, which is the second measured temperature Teb used in the calculation of the abnormality deviation, and determine whether or not the first temperature measurement section 47a measuring the target first measured temperature Tea is abnormal and whether or not the second temperature measurement section 47b measuring the target second measured temperature Teb is abnormal.

In the present aspect, it is determined whether or not the temperature deviation ΔTab, which is the difference between the first measured temperature Tea, which is the temperature measured by the first temperature measurement section 47a disposed in one small region Rs, and the second measured temperature Teb, which is the temperature measured by the second temperature measurement section 47b disposed in the small region Rs, exceeds the predetermined temperature deviation threshold value ΔTsh. When a temperature deviation ΔTab exceeds the temperature deviation threshold value ΔTsh, at least one temperature measurement section between the first temperature measurement section 47a and the second temperature measurement section 47b is likely to be abnormal. In this case, in the present aspect, the first temperature change rate dTea relating to the target first measured temperature Tea, which is the first measured temperature Tea used in the calculation of the abnormality deviation, which is the temperature deviation ΔTab exceeding the temperature deviation threshold value ΔTsh, is compared with the representative change rate obtained using the first temperature change rate dTea and the second temperature change rate dTeb for each of the plurality of small regions Rs. In the present aspect, furthermore, the representative change rate is compared with the second temperature change rate dTeb relating to the target second measured temperature Teb, which is the second measured temperature Teb used in the calculation of the abnormality deviation. Also, in the present aspect, the change rate abnormality determination sections 60s and 60l determine whether or not the first temperature measurement section 47a measuring the target first measured temperature Tea is abnormal and whether or not the second temperature measurement section 47b measuring the target second measured temperature Teb is abnormal from these comparison results.

(2) According to a second aspect, in the temperature measurement system SY according to the first aspect, the representative change rate calculation sections 70s and 70l extract a maximum change rate dTmax and a minimum change rate dTmim from the first temperature change rate dTea and the second temperature change rate dTeb for each of the plurality of small regions Rs and designate the maximum change rate dTmax and the minimum change rate dTmim as the representative change rate. The change rate abnormality determination sections 60s and 60l determine that the first temperature measurement section 47a measuring the target first measured temperature Tea is abnormal on the condition that the first temperature change rate dTea relating to the target first measured temperature Tea is the maximum change rate dTmax or the minimum change rate dTmim, and determine that the second temperature measurement section 47b measuring the target second measured temperature Teb is abnormal on the condition that the second temperature change rate dTeb relating to the target second measured temperature Teb is the maximum change rate dTmax or the minimum change rate dTmim.

As described in relation to the temperature measurement system SY according to the first aspect, when the temperature deviation ΔTab, which is the difference between the first measured temperature Tea and the second measured temperature Teb exceeds the predetermined temperature deviation threshold value ΔTsh, at least one temperature measurement section between the first temperature measurement section 47a and the second temperature measurement section 47b is likely to be abnormal. In this case, in the present aspect, the first temperature change rate dTea relating to the target first measured temperature Tea is compared with the minimum change rate dTmim and the maximum change rate dTmax among the first temperature change rates dTea and the second temperature change rates dTeb for each of the plurality of small regions Rs. In the present aspect, furthermore, the second temperature change rate dTeb relating to the target second measured temperature Teb is compared with the minimum change rate dTmim and the maximum change rate dTmax. Also, in the present aspect, the change rate abnormality determination sections 60s and 60l determine that the first temperature measurement section 47a measuring the target first measured temperature Tea is abnormal on the condition that the first temperature change rate dTea relating to the target first measured temperature Tea is the maximum change rate dTmax or the minimum change rate dTmim, and determine that the second temperature measurement section 47b measuring the target second measured temperature Teb is abnormal on the condition that the second temperature change rate dTeb relating to the target second measured temperature Teb is the maximum change rate dTmax or the minimum change rate dTmim.

(3) According to a third aspect, in the temperature measurement system SY according to the first aspect, the representative change rate calculation sections 70s and 70l obtain an average change rate dTav using the first temperature change rate dTea and the second temperature change rate dTeb for each of the plurality of small regions Rs and designate the average change rate dTav as the representative change rate. The change rate abnormality determination sections 60s and 60l determine that the first temperature measurement section 47a measuring the target first measured temperature Tea is abnormal on the condition that a first change rate deviation ΔdTa, which is the difference between the first temperature change rate dTea relating to the target first measured temperature Tea and the average change rate dTav, exceeds a predetermined change rate deviation threshold value ΔdTsh, and determine that the second temperature measurement section 47b measuring the target second measured temperature Teb is abnormal on the condition that a second change rate deviation ΔdTb, which is the difference between the second temperature change rate dTeb relating to the target second measured temperature Teb and the average change rate dTav, exceeds the change rate deviation threshold value ΔdTsh.

As described in relation to the temperature measurement system SY according to the first aspect, when the temperature deviation ΔTab, which is the difference between the first measured temperature Tea and the second measured temperature Teb, exceeds the predetermined temperature deviation threshold value ΔTsh, at least one temperature measurement section between the first temperature measurement section 47a and the second temperature measurement section 47b is likely to be abnormal. In this case, in the present aspect, the first change rate deviation ΔdTa, which is the difference between the first temperature change rate dTea relating to the target first measured temperature Tea and the average change rate dTav obtained using the first temperature change rate dTea and the second temperature change rate dTeb for each of the plurality of small regions Rs, is obtained. In the present aspect, furthermore, the second change rate deviation ΔdTb, which is the difference between the second temperature change rate dTeb relating to the target second measured temperature Teb and the average change rate dTav, is obtained. Also, in the present aspect, the change rate abnormality determination sections 60s and 60l determine that the first temperature measurement section 47a measuring the target first measured temperature Tea is abnormal on the condition that the first change rate deviation ΔdTa exceeds the predetermined change rate deviation threshold value ΔdTsh, and determine that the second temperature measurement section 47b measuring the target second measured temperature Teb is abnormal on the condition that the second change rate deviation ΔdTb exceeds the change rate deviation threshold value ΔdTsh.

(4) According to a fourth aspect, in the temperature measurement system SY according to the first aspect, the representative change rate calculation sections 70s and 70l extract a maximum change rate dTmax and a minimum change rate dTmim from the first temperature change rate dTea and the second temperature change rate dTeb for each of the plurality of small regions Rs, obtain an average change rate dTav using the first temperature change rate dTea and the second temperature change rate dTeb for each of the plurality of small regions Rs, and designate the maximum change rate dTmax, the minimum change rate dTmim, and the average change rate dTav as the representative change rate. The change rate abnormality determination sections 60s and 60l determine that the first temperature measurement section 47a measuring the target first measured temperature Tea is abnormal on the condition that a first change rate deviation ΔdTa, which is the difference between the first temperature change rate dTea relating to the target first measured temperature Tea and the average change rate dTav, exceeds a predetermined change rate deviation threshold value ΔdTsh, determine that the second temperature measurement section 47b measuring the target second measured temperature Teb is abnormal on the condition that a second change rate deviation ΔdTb, which is the difference between the second temperature change rate dTeb relating to the target second measured temperature Teb and the average change rate dTav, exceeds the change rate deviation threshold value ΔdTsh, determine a larger change rate deviation between the first change rate deviation ΔdTa and the second change rate deviation ΔdTb when the first change rate deviation ΔdTa does not exceed the change rate deviation threshold value ΔdTsh and the second change rate deviation ΔdTb does not exceed the change rate deviation threshold value ΔdTsh, and determine that a temperature measurement section measuring a target measured temperature Tea or Teb corresponding to the larger change rate deviation between the first temperature measurement section 47a and the second temperature measurement section 47b is abnormal on the condition that a temperature change rate indicating the larger change rate deviation between the first temperature change rate dTea and the second temperature change rate dTeb is the maximum change rate dTmax or the minimum change rate dTmim.

As described in relation to the temperature measurement system SY according to the first aspect, when the temperature deviation ΔTab, which is the difference between the first measured temperature Tea and the second measured temperature Teb, exceeds the predetermined temperature deviation threshold value ΔTsh, at least one temperature measurement section between the first temperature measurement section 47a and the second temperature measurement section 47b is likely to be abnormal. In this case, in the present aspect, the first change rate deviation ΔdTa, which is the difference between the first temperature change rate dTea relating to the target first measured temperature Tea and the average change rate dTav obtained using the first temperature change rate dTea and the second temperature change rate dTeb for each of the plurality of small regions Rs, is obtained. In the present aspect, furthermore, the second change rate deviation ΔdTb, which is the difference between the second temperature change rate dTeb relating to the target second measured temperature Teb and the average change rate dTav, is obtained. Also, in the present aspect, the change rate abnormality determination sections 60s and 60l determine that the first temperature measurement section 47a measuring the target first measured temperature Tea is abnormal on the condition that the first change rate deviation ΔdTa exceeds the predetermined change rate deviation threshold value ΔdTsh, and determine that the second temperature measurement section 47b measuring the target second measured temperature Teb is abnormal on the condition that the second change rate deviation ΔdTb exceeds the change rate deviation threshold value ΔdTsh. Furthermore, in the present aspect, the larger change rate deviation between the first change rate deviation ΔdTa between the first temperature change rates dTea and the second change rate deviation ΔdTb between the second temperature change rates dTeb is determined when the first change rate deviation ΔdTa does not exceed the change rate deviation threshold value ΔdTsh and the second change rate deviation ΔdTb does not exceed the change rate deviation threshold value ΔdTsh. Also, in the present aspect, the change rate abnormality determination sections 60s and 60l determine that a temperature measurement section measuring a target measured temperature Tea or Teb corresponding to the larger change rate deviation ΔdTL (=ΔdTa or ΔdTb) between the first temperature measurement section 47a and the second temperature measurement section 47b is abnormal on the condition that the temperature change rate dTeL (=dTea or dTeb) indicating the larger change rate deviation ΔdTL (=ΔdTa or ΔdTb) between the first temperature change rate dTea and the second temperature change rate dTeb is the maximum change rate dTmax or the minimum change rate dTmim.

(5) According to a fifth aspect, in the temperature measurement system SY according to the third or fourth aspect, the average change rate dTav obtained by the representative change rate calculation sections 70s and 70l is an average change rate dTav of all change rates other than a maximum change rate dTmax and a minimum change rate dTmim among first temperature change rates dTea and second temperature change rates dTeb for each of the plurality of small regions Rs.

The temperature measurement section measuring the first measured temperature Tea or the second measured temperature Teb indicating the maximum change rate dTmax or the minimum change rate dTmim between the first temperature change rate dTea and the second temperature change rate dTeb for each of the plurality of small regions Rs is likely to be abnormal. Therefore, in the present aspect, the accuracy of abnormality determination is improved using the average change rate dTav of all change rates other than the maximum change rate dTmax and the minimum change rate dTmim among first temperature change rates dTea and second temperature change rates dTeb for each of the plurality of small regions Rs as the average change rate dTav for use in determining whether or not the first temperature measurement section 47a and the second temperature measurement section 47b are abnormal.

(6) According to a sixth aspect, in the temperature measurement system SY according to any one of the third to fifth aspects, when a parameter serving as a cause of a change in the temperature in the large region Rb has changed to a predetermined value or more, the change rate abnormality determination sections 60s and 60l determine that the first temperature measurement section 47a measuring the target first measured temperature Tea is not abnormal even though the first change rate deviation ΔdTa exceeds the change rate deviation threshold value ΔdTsh and determine that the second temperature measurement section 47b measuring the target second measured temperature Teb is not abnormal even though the second change rate deviation ΔdTb exceeds the change rate deviation threshold value ΔdTsh.

In this aspect, when the change in the parameter serving as the cause of the temperature change in the large region Rb is large, the change rate deviation ΔdT between the temperature change rate for the measured temperatures Tea and Teb and the average change rate dTav is larger than when the change in this parameter is small. For this reason, when the change in the parameter is large, even if the temperature measurement sections measuring the target measured temperatures Tea and Teb are normal, the change rate deviation ΔdT may be greater than the change rate deviation threshold value ΔdTsh and the temperature measurement section may be determined to be abnormal. Therefore, in the present aspect, the accuracy of the abnormality determination is improved by determining that the temperature measurement sections measuring the target measured temperatures Tea and Teb are not abnormal even if the change rate deviation ΔdT exceeds the change rate deviation threshold value ΔdTsh when the change in the parameter is large to improve the accuracy of the abnormality determination.

(7) According to a seventh aspect, in the temperature measurement system SY according to any one of the first to sixth aspects, the change rate calculation sections 55s and 55l include a short-time change rate calculation section 55s configured to obtain a short-time first temperature change rate dTea, which is the change rate of the first measured temperature Tea per short unit time, and a short-time second temperature change rate dTeb, which is the change rate of the second measured temperature Teb per short unit time, and a long-time change rate calculation section 55l configured to obtain a long-time first temperature change rate, which is the change rate of the first measured temperature Tea per long unit time longer than the short unit time, and a long-time second temperature change rate, which is the change rate of the second measured temperature Teb per long unit time. The representative change rate calculation sections 70s and 70l include a short-time representative change rate calculation section 70s configured to obtain a short-time representative change rate, which is the representative change rate for the short unit time, and a long-time representative change rate calculation section 70l configured to obtain a long-time representative change rate, which is the representative change rate for the long unit time. The change rate abnormality determination sections 60s and 60l include a short-time change rate abnormality determination section 60s configured to determine whether or not the first temperature measurement section 47a measuring the target first measured temperature Tea and the second temperature measurement section 47b measuring the target second measured temperature Teb are abnormal using the short-time representative change rate, and a long-time change rate abnormality determination section 60l configured to determine whether or not the first temperature measurement section 47a measuring the target first measured temperature Tea and the second temperature measurement section 47b measuring the target second measured temperature Teb are abnormal using the long-time representative change rate.

If the type of the temperature measurement section and the failure location in the temperature measurement section are different, the response time from the time when the temperature change in the small region Rs occurs to the time when the measured temperatures Tea and Teb output from the temperature measurement sections change may change. Therefore, in the present aspect, the accuracy of the abnormality determination is improved by determining the abnormality of the temperature measurement section on the basis of the temperature change rate per unit time relating to two types of unit time that are different from each other.

(8) According to an eighth aspect, the temperature measurement system SY according to any one of the first to seventh aspects includes a range abnormality determination section 68 provided for each of the plurality of small regions Rs. The range abnormality determination section 68 determines that the first temperature measurement section 47a measuring the target first measured temperature Tea is abnormal when the target first measured temperature Tea is outside of the normal temperature range, and determines that the second temperature measurement section 47b measuring the target second measured temperature Teb is abnormal when the target second measured temperature Teb is outside of the normal temperature range.

In the present aspect, it is determined that the temperature measurement section measuring the measured temperature Tea or Teb is abnormal when the measured temperature is outside of a normal temperature range predetermined for the large region Rb.

(9) According to a ninth aspect, the temperature measurement system SY according to any one of the first to eighth aspects includes a selection section 69 configured to send a temperature measured by a temperature measurement section determined not to be abnormal between the first temperature measurement section 47a and the second temperature measurement section 47b for each of the plurality of small regions Rs to a control device 90 for controlling an operation of the measurement target.

In the present aspect, the temperature is sent to the control device 90 for controlling the temperature measured by a temperature measurement section determined not to be abnormal. Thus, it is possible to suppress the occurrence of a malfunction of control of the control device 90.

A temperature measurement method according to the above-described embodiment, for example, is ascertained as follows.

(10) According to a tenth aspect, there is provided a temperature measurement method including: a first temperature measurement step S11a of measuring a temperature of a small region Rs for each of a plurality of small regions Rs into which a large region Rb where a normal temperature range is predetermined is divided in a measurement target in a first temperature measurement section 47a; a second temperature measurement step S11b of measuring a temperature of a small region Rs for each of the plurality of small regions Rs in a second temperature measurement section 47b; a temperature deviation calculation step S12 of obtaining a temperature deviation ΔTab, which is the difference between a first measured temperature Tea, which is a temperature measured in the first temperature measurement step S11a, and a second measured temperature Teb, which is a temperature measured in the second temperature measurement step S11b, for each of the plurality of small regions Rs; a deviation abnormality determination step S13 of determining whether or not the temperature deviation ΔTab exceeds a predetermined temperature deviation threshold value ΔTsh for each of the plurality of small regions Rs; change rate calculation steps S14s and S14l of obtaining a first temperature change rate dTea, which is the change rate per unit time in the first measured temperature Tea, and a second temperature change rate dTeb, which is the change rate per unit time in the second measured temperature Teb for each of the plurality of small regions Rs; representative change rate calculation steps S20s and S201 of obtaining a representative change rate, which is a value representative of the temperature change rate for each of the plurality of small regions Rs, using the first temperature change rate dTea and the second temperature change rate dTeb for each of the plurality of small regions Rs; and change rate abnormality determination steps S15s and S15l of comparing the representative change rate with the first temperature change rate dTea relating to a target first measured temperature Tea, which is the first measured temperature Tea used in calculation of an abnormality deviation, which is the temperature deviation ΔTab exceeding the temperature deviation threshold value ΔTsh, when the temperature deviation ΔTab exceeds the temperature deviation threshold value ΔTsh for each of the plurality of small regions Rs, comparing the representative change rate with the second temperature change rate dTeb relating to a target second measured temperature Teb, which is the second measured temperature Teb used in the calculation of the abnormality deviation, and determining whether or not the first temperature measurement section 47a measuring the target first measured temperature Tea is abnormal and whether or not the second temperature measurement section 47b measuring the target second measured temperature Teb is abnormal.

Also, in the present aspect, as in the temperature measurement system SY according to the first aspect, it is possible to determine whether or not the first temperature measurement section 47a measuring the target first measured temperature Tea is abnormal and whether or not the second temperature measurement section 47b measuring the target second measured temperature Teb is abnormal.

(11) According to an eleventh aspect, in the temperature measurement method according to the tenth aspect, the representative change rate calculation steps S20s and S201 include extracting a maximum change rate dTmax and a minimum change rate dTmim from the first temperature change rate dTea and the second temperature change rate dTeb for each of the plurality of small regions Rs and designating the maximum change rate dTmax and the minimum change rate dTmim as the representative change rate. The change rate abnormality determination steps S15s and S15l include determining that the first temperature measurement section 47a measuring the target first measured temperature Tea is abnormal on the condition that the first temperature change rate dTea relating to the target first measured temperature Tea is the maximum change rate dTmax or the minimum change rate dTmim, and determining that the second temperature measurement section 47b measuring the target second measured temperature Teb is abnormal on the condition that the second temperature change rate dTeb relating to the target second measured temperature Teb is the maximum change rate dTmax or the minimum change rate dTmim.

Also, in the present aspect, as in the temperature measurement system SY according to the second aspect, it is possible to determine that the first temperature measurement section 47a measuring the target first measured temperature Tea is abnormal on the condition that the first temperature change rate dTea is the maximum change rate dTmax or the minimum change rate dTmim. Furthermore, it is possible to determine that the second temperature measurement section 47b measuring the target second measured temperature Teb is abnormal on the condition that the second temperature change rate dTeb is the maximum change rate dTmax or the minimum change rate dTmim.

(12) According to a twelfth aspect, in the temperature measurement method according to the tenth aspect, the representative change rate calculation steps S20s and S201 include obtaining an average change rate dTav using the first temperature change rate dTea and the second temperature change rate dTeb for each of the plurality of small regions Rs and designating the average change rate dTav as the representative change rate. The change rate abnormality determination steps S15s and S15l include determining that the first temperature measurement section 47a measuring the target first measured temperature Tea is abnormal on the condition that a difference between the first temperature change rate dTea relating to the target first measured temperature Tea and the average change rate dTav exceeds a predetermined change rate deviation threshold value ΔdTsh, and determining that the second temperature measurement section 47b measuring the target second measured temperature Teb is abnormal on the condition that a difference between the second temperature change rate dTeb relating to the target second measured temperature Teb and the average change rate dTav exceeds the change rate deviation threshold value ΔdTsh.

Also, in the present aspect, as in the temperature measurement system SY according to the third aspect, it is possible to determine that the first temperature measurement section 47a measuring the target first measured temperature Tea is abnormal on the condition that a first change rate deviation ΔdTa exceeds the predetermined change rate deviation threshold value ΔdTsh. Furthermore, it is possible to determine that the second temperature measurement section 47b measuring the target second measured temperature Teb is abnormal on the condition that a second change rate deviation ΔdTb exceeds the change rate deviation threshold value ΔdTsh.

(13) According to a thirteenth aspect, in the temperature measurement method according to the tenth aspect, the representative change rate calculation steps S20s and S201 include extracting a maximum change rate dTmax and a minimum change rate dTmim from the first temperature change rate dTea and the second temperature change rate dTeb for each of the plurality of small regions Rs, obtaining an average change rate dTav using the first temperature change rate dTea and the second temperature change rate dTeb for each of the plurality of small regions Rs, and designating the maximum change rate dTmax, the minimum change rate dTmim, and the average change rate dTav as the representative change rate. The change rate abnormality determination steps S15s and S15l include determining that the first temperature measurement section 47a measuring the target first measured temperature Tea is abnormal on the condition that a first change rate deviation ΔdTa, which is the difference between the first temperature change rate dTea relating to the target first measured temperature Tea and the average change rate dTav, exceeds a predetermined change rate deviation threshold value ΔdTsh, determining that the second temperature measurement section 47b measuring the target second measured temperature Teb is abnormal on the condition that a second change rate deviation ΔdTb, which is the difference between the second temperature change rate dTeb relating to the target second measured temperature Teb and the average change rate dTav, exceeds the change rate deviation threshold value ΔdTsh, determining a larger change rate deviation ΔdTL (=ΔdTa or ΔdTb) between the first change rate deviation ΔdTa and the second change rate deviation ΔdTb when the first change rate deviation dTa does not exceed the change rate deviation threshold value ΔdTsh and the second change rate deviation ΔdTb does not exceed the change rate deviation threshold value dTsh, and determining that a temperature measurement section measuring a target measured temperature Tea or Teb corresponding to the larger change rate deviation ΔdTL (=ΔdTa or ΔdTb) between the first temperature measurement section 47a and the second temperature measurement section 47b is abnormal on the condition that a temperature change rate dTeL (=dTea or dTeb) indicating the larger change rate deviation ΔdTL between the first temperature change rate dTea and the second temperature change rate dTeb is the maximum change rate dTmax or the minimum change rate dTmim.

Also, in the present aspect, as in the temperature measurement system SY according to the fourth aspect, it is possible to determine that the first temperature measurement section 47a measuring the target first measured temperature Tea is abnormal on the condition that a first change rate deviation ΔdTa exceeds the predetermined change rate deviation threshold value ΔdTsh. Furthermore, it is possible to determine that the second temperature measurement section 47b measuring the target second measured temperature Teb is abnormal on the condition that a second change rate deviation ΔdTb exceeds the change rate deviation threshold value ΔdTsh. Also, in the present aspect, the larger change rate deviation ΔdTL (=ΔdTa or ΔdTb) between the first change rate deviation ΔdTa and the second change rate deviation ΔdTb between the first temperature change rates dTea and the second temperature change rates dTeb is determined when the first change rate deviation ΔdTa does not exceed the change rate deviation threshold value ΔdTsh and the second change rate deviation ΔdTb does not exceed the change rate deviation threshold value ΔdTsh. Also, in the present aspect, the change rate abnormality determination steps S15s and S15l include determining that a temperature measurement section measuring a target measured temperature Tea or Teb corresponding to the larger change rate deviation ΔdTL (=ΔdTa or ΔdTb) between the first temperature measurement section 47a and the second temperature measurement section 47b is abnormal on the condition that the temperature change rate dTeL (=dTea or dTeb) indicating the larger change rate deviation ΔdTL (=ΔdTa or ΔdTb) between the first temperature change rate dTea and the second temperature change rate dTeb is the maximum change rate dTmax or the minimum change rate dTmim.

(14) According to a fourteenth aspect, in the temperature measurement method according to the twelfth or thirteenth aspect, the average change rate dTav obtained in the representative change rate calculation steps S20s and S201 is an average change rate dTav of all change rates other than a maximum change rate dTmax and a minimum change rate dTmim among first temperature change rates dTea and second temperature change rates dTeb for each of the plurality of small regions Rs.

Also, in the present aspect, as in the temperature measurement system SY according to the fifth aspect, the accuracy of the abnormality determination can be improved.

(15) According to a fifteenth aspect, in the temperature measurement method according to any one of the twelfth to fourteenth aspects, when a parameter serving as a cause of a change in the temperature in the large region Rb has changed to a predetermined value or more, the change rate abnormality determination steps S15s and S15l include determining that the first temperature measurement section 47a measuring the target first measured temperature Tea is not abnormal even though a difference between the first change rate deviation dTa relating to the target first measured temperature Tea and the average change rate dTav exceeds the change rate deviation threshold value ΔdTsh and determining that the second temperature measurement section 47b measuring the target second measured temperature Teb is not abnormal even though a difference between the second change rate deviation dTb relating to the target second measured temperature Teb and the average change rate dTav exceeds the change rate deviation threshold value ΔdTsh.

Also, in the present aspect, as in the temperature measurement system SY according to the sixth aspect, the accuracy of the abnormality determination can be improved.

(16) According to a sixteenth aspect, in the temperature measurement method according to any one of the twelfth to fourteenth aspects, the measurement target is a gas turbine 1 including a compressor 10 capable of compressing air A and generating the compressed air, a plurality of combustors 20 capable of generating combustion gas by burning fuel F in the compressed air, and a turbine 30 capable of being driven by the combustion gas. The turbine 30 includes a turbine rotor 32 capable of rotating around an axis Ar, a turbine casing 36 configured to cover outer circumference of the turbine rotor 32, and an exhaust casing 7 connected to the turbine casing 36 and in which exhaust gas EG that is combustion gas passing through the turbine rotor 32 can circulate. The large region Rb is an annular region centered on the axis Ar in the exhaust casing 7. The plurality of small regions Rs are regions into which the large region Rb is divided in a circumferential direction Dc with respect to the axis Ar. When a flow rate of fuel F to be supplied to the plurality of combustors 20 has changed to a predetermined value or more, the change rate abnormality determination steps S15s and S15l include determining that the first temperature measurement section 47a measuring the target first measured temperature Tea is not abnormal even though a difference between the first temperature change rate dTea relating to the target first measured temperature Tea and the average change rate dTav exceeds the change rate deviation threshold value ΔdTsh and determining that the second temperature measurement section 47b measuring the target second measured temperature Teb is not abnormal even though a difference between the second temperature change rate dTeb relating to the target second measured temperature Teb and the average change rate dTav exceeds the change rate deviation threshold value ΔdTsh.

In this aspect, when the change ΔF in the fuel flow rate serving as the cause of the temperature change in the large region Rb is large, the change rate deviation ΔdT between the temperature change rate for the measured temperatures Tea and Teb and the average change rate dTav becomes larger than when the change ΔF in the fuel flow rate is small. For this reason, when the change ΔF in the fuel flow rate is large, even if the temperature measurement sections measuring the target measured temperatures Tea and Teb are normal, the change rate deviation ΔdT becomes larger than the change rate deviation threshold value ΔdTsh and the temperature measurement section may be determined to be abnormal. Therefore, in the present aspect, the accuracy of the abnormality determination is improved by determining that the temperature measurement sections measuring the target measured temperatures Tea and Teb are not abnormal even if the change rate deviation ΔdT exceeds the change rate deviation threshold value ΔdTsh when the change ΔF in the fuel flow rate is large to improve the accuracy of the abnormality determination.

(17) According to a seventeenth aspect, in the temperature measurement method according to any one of the tenth to sixteenth aspects, the change rate calculation steps S14s and S14l include a short-time change rate calculation step S14s of obtaining a short-time first temperature change rate dTea, which is the change rate of the first measured temperature Tea per short unit time, and a short-time second temperature change rate dTeb, which is the change rate of the second measured temperature Teb per short unit time, and a long-time change rate calculation step S14l of obtaining a long-time first temperature change rate, which is the change rate of the first measured temperature Tea per long unit time longer than the short unit time, and a long-time second temperature change rate, which is the change rate of the second measured temperature Teb per long unit time. The representative change rate calculation steps S20s and S201 include a short-time representative change rate calculation step S20s of obtaining a short-time representative change rate, which is the representative change rate for the short unit time, and a long-time representative change rate calculation step S201 of obtaining a long-time representative change rate, which is the representative change rate for the long unit time. The change rate abnormality determination steps S15s and S15l include a short-time change rate abnormality determination step S15s of determining whether or not the first temperature measurement section 47a measuring the target first measured temperature Tea and the second temperature measurement section 47b measuring the target second measured temperature Teb are abnormal using the short-time representative change rate, and a long-time change rate abnormality determination step S15l of determining whether or not the first temperature measurement section 47a measuring the target first measured temperature Tea and the second temperature measurement section 47b measuring the target second measured temperature Teb are abnormal using the long-time representative change rate.

Also, in the present aspect, as in the temperature measurement system SY according to the seventh aspect, the accuracy of the abnormality determination can be improved.

(18) According to an eighteenth aspect, the temperature measurement method according to any one of the tenth to seventeenth aspects includes a range abnormality determination step S16 executed for each of the plurality of small regions Rs. The range abnormality determination step S16 includes determining that the first temperature measurement section 47a measuring the target first measured temperature Tea is abnormal when the target first measured temperature Tea is outside of the normal temperature range, and determining that the second temperature measurement section 47b measuring the target second measured temperature Teb is abnormal when the target second measured temperature Teb is outside of the normal temperature range.

In the present aspect, as in the temperature measurement system SY according to the eighth aspect, it can be determined that the temperature measurement section measuring the measured temperature Tea or Teb is abnormal when the measured temperature is outside of a normal temperature range predetermined for the large region Rb.

(19) According to a nineteenth aspect, the temperature measurement method according to any one of the tenth to eighteenth aspects includes a selection step S17 of sending a temperature measured by a temperature measurement section determined not to be abnormal between the first temperature measurement section 47a and the second temperature measurement section 47b for each of the plurality of small regions Rs to a control device 90 for controlling an operation of the measurement target.

Also, in the present aspect, as in the temperature measurement system SY according to the tenth aspect, it is possible to suppress the occurrence of a malfunction of control of the control device 90.

### EXPLANATION OF REFERENCES

1 Gas turbine
2 Gas turbine rotor
5 Gas turbine casing
6 Intermediate casing
7 Exhaust casing
8 Fuel line
8V Fuel valve
9 Power generator
10 Compressor
12 Compressor rotor
13 Rotor axis
14 Blade array
15 Vane array
16 Compressor casing
17 Suction amount adjuster (IGV)
17V Vane
17d Drive
20 Combustor
30 Turbine
32 Turbine rotor
33 Rotor shaft
34 Blade array
35 Vane array
36 Turbine casing
40 Tachometer
41 Output meter
42 Intake air temperature meter
43 Intake air pressure meter
44 Casing temperature meter
45 Internal casing pressure meter
46 Fuel flow rate meter
47 Upstream-side exhaust gas temperature meter
47a First temperature measurement section
47b Second temperature measurement section
47c Sheath tube
48 Downstream-side exhaust gas temperature meter
50 Temperature signal processing device
51 Signal processing section
52 Temperature deviation calculation section
53 Deviation abnormality determination section
54 Magnitude comparator
55s Short-time change rate calculation section
55l Long-time change rate calculation section
56a Short-time first temperature change rate calculation section
57a Delay device
58a Differential device
56b Short-time second temperature change rate calculation section
57b Delay device
58b Differential device
60s Short-time change rate abnormality determination section
60l Long-time change rate abnormality determination section
61a First differential device
62a First magnitude comparator
63a First AND circuit
61b Second differential device
62b Second magnitude comparator
63b Second AND circuit
64 Third magnitude comparator
65 Change rate selector
66 Change rate comparator
67 Third AND Circuit
68 Range abnormality determination section
69 Selection section
70s Short-time representative change rate calculation section
70l Long-time representative change rate calculation section
71 Maximum and minimum change rate extraction section
72 Maximum and minimum change rate removal section
73 Average change rate calculation section
90 Control device
SY Temperature measurement system
A Air
F Fuel
EG Exhaust gas
Rb Large region
Rs Small region
Ar Axis
Da Axial direction
Dau Upstream axial side
Dad Downstream axial side
Dc Circumferential direction
Dr Radial direction

What is claimed is:

1. A temperature measurement system comprising:
first and second temperature measurement sections provided for each of a plurality of small regions into which a large region where a normal temperature range is predetermined is divided in a measurement target and configured to measure a temperature within the small region;
a temperature deviation calculation section provided for each of the plurality of small regions and configured to obtain a temperature deviation, which is a difference between a first measured temperature, which is a temperature measured by the first temperature measurement section, and a second measured temperature, which is a temperature measured by the second temperature measurement section;
a deviation abnormality determination section provided for each of the plurality of small regions and configured to determine whether or not the temperature deviation exceeds a predetermined temperature deviation threshold value;
change rate calculation sections provided for each of the plurality of small regions and configured to obtain a first temperature change rate, which is a change rate per unit time in the first measured temperature, and a second temperature change rate, which is a change rate per unit time in the second measured temperature;
representative change rate calculation sections configured to obtain a representative change rate, which is a value representative of the temperature change rate for each of the plurality of small regions, using the first temperature change rate and the second temperature change rate for each of the plurality of small regions; and
change rate abnormality determination sections provided for each of the plurality of small regions and configured to compare the representative change rate with the first temperature change rate relating to a target first measured temperature, which is the first measured temperature used in calculation of an abnormality deviation, which is the temperature deviation exceeding the temperature deviation threshold value, when the temperature deviation exceeds the temperature deviation threshold value, compare the representative change rate with the second temperature change rate relating to a target second measured temperature, which is the second measured temperature used in the calculation of the abnormality deviation, and determine whether or not the first temperature measurement section measuring the target first measured temperature is abnormal and whether or not the second temperature measurement section measuring the target second measured temperature is abnormal.

2. The temperature measurement system according to claim 1,
wherein the representative change rate calculation sections extract a maximum change rate and a minimum change rate from the first temperature change rate and the second temperature change rate for each of the plurality of small regions and designate the maximum change rate and the minimum change rate as the representative change rate, and
wherein the change rate abnormality determination sections
determine that the first temperature measurement section measuring the target first measured temperature is abnormal on the condition that the first temperature change rate relating to the target first measured temperature is the maximum change rate or the minimum change rate, and
determine that the second temperature measurement section measuring the target second measured temperature is abnormal on the condition that the second temperature change rate relating to the target second measured temperature is the maximum change rate or the minimum change rate.

3. The temperature measurement system according to claim 1,
wherein the representative change rate calculation sections obtain an average change rate using the first temperature change rate and the second temperature change rate for each of the plurality of small regions and designate the average change rate as the representative change rate, and
wherein the change rate abnormality determination sections
determine that the first temperature measurement section measuring the target first measured temperature is abnormal on the condition that a first change rate deviation, which is a difference between the first temperature change rate relating to the target first measured temperature and the average change rate, exceeds a predetermined change rate deviation threshold value, and
determine that the second temperature measurement section measuring the target second measured temperature is abnormal on the condition that a second change rate deviation, which is a difference between the second temperature change rate relating to the target second measured temperature and the average change rate, exceeds the change rate deviation threshold value.

4. The temperature measurement system according to claim 1,
wherein the representative change rate calculation sections extract a maximum change rate and a minimum change rate from the first temperature change rate and the second temperature change rate for each of the plurality of small regions, obtain an average change rate using the first temperature change rate and the second temperature change rate for each of the plurality of small regions, and designate the maximum change rate, the minimum change rate, and the average change rate as the representative change rate, and
wherein the change rate abnormality determination sections
determine that the first temperature measurement section measuring the target first measured temperature is abnormal on the condition that a first change rate deviation, which is a difference between the first temperature change rate relating to the target first measured temperature and the average change rate, exceeds a predetermined change rate deviation threshold value,
determine that the second temperature measurement section measuring the target second measured temperature is abnormal on the condition that a second change rate deviation, which is a difference between the second temperature change rate relating to the target second measured temperature and the average change rate, exceeds the change rate deviation threshold value,
determine a larger change rate deviation between the first change rate deviation and the second change rate deviation when the first change rate deviation does not exceed the change rate deviation threshold value and the second change rate deviation does not exceed the change rate deviation threshold value, and
determine that a temperature measurement section measuring a target measured temperature corresponding to the larger change rate deviation between the first temperature measurement section and the second temperature measurement section is abnormal on the condition that a temperature change rate indicating the larger change rate deviation between the first temperature change rate and the second temperature change rate is the maximum change rate or the minimum change rate.

5. The temperature measurement system according to claim 3, wherein the average change rate obtained by the representative change rate calculation sections is an average change rate of all change rates other than a maximum change rate and a minimum change rate among first temperature change rates and second temperature change rates for each of the plurality of small regions.

6. The temperature measurement system according to claim 3, wherein, when a parameter serving as a cause of a change in the temperature in the large region has changed to a predetermined value or more, the change rate abnormality determination sections determine that the first temperature measurement section measuring the target first measured temperature is not abnormal even though the first change rate deviation exceeds the change rate deviation threshold value and determine that the second temperature measurement section measuring the target second measured temperature is not abnormal even though the second change rate deviation exceeds the change rate deviation threshold value.

7. The temperature measurement system according to claim 1,
wherein the change rate calculation sections include
a short-time change rate calculation section configured to obtain a short-time first temperature change rate, which is a change rate of the first measured temperature per short unit time, and a short-time second temperature change rate, which is a change rate of the second measured temperature per short unit time, and
a long-time change rate calculation section configured to obtain a long-time first temperature change rate, which is a change rate of the first measured temperature per long unit time longer than the short unit time, and a long-time second temperature change rate, which is a change rate of the second measured temperature per long unit time,
wherein the representative change rate calculation sections include
a short-time representative change rate calculation section configured to obtain a short-time representative change rate, which is the representative change rate for the short unit time, and
a long-time representative change rate calculation section configured to obtain a long-time representative change rate, which is the representative change rate for the long unit time, and
wherein the change rate abnormality determination sections include
a short-time change rate abnormality determination section configured to determine whether or not the first temperature measurement section measuring the target first measured temperature and the second temperature measurement section measuring the target second measured temperature are abnormal using the short-time representative change rate, and
a long-time change rate abnormality determination section configured to determine whether or not the first temperature measurement section measuring the target first measured temperature and the second temperature measurement section measuring the target second measured temperature are abnormal using the long-time representative change rate.

8. The temperature measurement system according to claim 1, comprising a range abnormality determination section provided for each of the plurality of small regions,
wherein the range abnormality determination sections
determine that the first temperature measurement section measuring the target first measured temperature is abnormal when the target first measured temperature is outside of the normal temperature range, and
determine that the second temperature measurement section measuring the target second measured temperature is abnormal when the target second measured temperature is outside of the normal temperature range.

9. The temperature measurement system according to claim 1, comprising a selection section configured to send a temperature measured by a temperature measurement section determined not to be abnormal between the first temperature measurement section and the second temperature measurement section for each of the plurality of small regions to a control device for controlling an operation of the measurement target.

10. A temperature measurement method comprising:
a first temperature measurement step of measuring a temperature of a small region for each of a plurality of small regions into which a large region where a normal temperature range is predetermined is divided in a measurement target in a first temperature measurement section;
a second temperature measurement step of measuring a temperature of a small region for each of the plurality of small regions in a second temperature measurement section;
a temperature deviation calculation step of obtaining a temperature deviation, which is a difference between a first measured temperature, which is a temperature measured in the first temperature measurement step, and a second measured temperature, which is a temperature measured in the second temperature measurement step, for each of the plurality of small regions;
a deviation abnormality determination step of determining whether or not the temperature deviation exceeds a predetermined temperature deviation threshold value for each of the plurality of small regions;
change rate calculation steps of obtaining a first temperature change rate, which is a change rate per unit time in the first measured temperature, and a second temperature change rate, which is a change rate per unit time in the second measured temperature for each of the plurality of small regions;
representative change rate calculation steps of obtaining a representative change rate, which is a value representative of the temperature change rate for each of the plurality of small regions, using the first temperature change rate and the second temperature change rate for each of the plurality of small regions; and
change rate abnormality determination steps of comparing the representative change rate with the first temperature change rate relating to a target first measured temperature, which is the first measured temperature used in calculation of an abnormality deviation, which is the temperature deviation exceeding the temperature deviation threshold value, when the temperature deviation exceeds the temperature deviation threshold value for each of the plurality of small regions, comparing the representative change rate with the second temperature change rate relating to a target second measured temperature, which is the second measured temperature used in the calculation of the abnormality deviation, and determining whether or not the first temperature measurement section measuring the target first measured temperature is abnormal and whether or not the second temperature measurement section measuring the target second measured temperature is abnormal.

11. The temperature measurement method according to claim 10,
wherein the representative change rate calculation steps include extracting a maximum change rate and a minimum change rate from the first temperature change rate and the second temperature change rate for each of the plurality of small regions and designating the maximum change rate and the minimum change rate as the representative change rate, and
wherein the change rate abnormality determination steps include
determining that the first temperature measurement section measuring the target first measured temperature is abnormal on the condition that the first temperature change rate relating to the target first measured temperature is the maximum change rate or the minimum change rate, and
determining that the second temperature measurement section measuring the target second measured temperature is abnormal on the condition that the second temperature change rate relating to the target second measured temperature is the maximum change rate or the minimum change rate.

12. The temperature measurement method according to claim 10,
wherein the representative change rate calculation steps include obtaining an average change rate using the first temperature change rate and the second temperature change rate for each of the plurality of small regions and designating the average change rate as the representative change rate, and
wherein the change rate abnormality determination steps include
determining that the first temperature measurement section measuring the target first measured temperature is abnormal on the condition that a difference between the first temperature change rate relating to the target first measured temperature and the average change rate exceeds a predetermined change rate deviation threshold value, and
determining that the second temperature measurement section measuring the target second measured temperature is abnormal on the condition that a difference between the second temperature change rate relating to the target second measured temperature and the average change rate exceeds the change rate deviation threshold value.

13. The temperature measurement method according to claim 10,
wherein the representative change rate calculation steps include extracting a maximum change rate and a minimum change rate from the first temperature change rate and the second temperature change rate for each of the plurality of small regions, obtaining an average change rate using the first temperature change rate and the second temperature change rate for each of the plurality of small regions, and designating the maximum change rate, the minimum change rate, and the average change rate as the representative change rate, and
wherein the change rate abnormality determination steps include
determining that the first temperature measurement section measuring the target first measured temperature is abnormal on the condition that a first change rate deviation, which is a difference between the first temperature change rate relating to the target first measured temperature and the average change rate, exceeds a predetermined change rate deviation threshold value,
determining that the second temperature measurement section measuring the target second measured temperature is abnormal on the condition that a second change rate deviation, which is a difference between the second temperature change rate relating to the target second measured temperature and the average change rate, exceeds the change rate deviation threshold value,
determining a larger change rate deviation between the first change rate deviation and the second change rate deviation when the first change rate deviation does not exceed the change rate deviation threshold value and the second change rate deviation does not exceed the change rate deviation threshold value, and
determining that a temperature measurement section measuring a target measured temperature corresponding to the larger change rate deviation between the first temperature measurement section and the second temperature measurement section is abnormal on the condition that a temperature change rate indicating the larger change rate deviation between the first temperature change rate and the second temperature change rate is the maximum change rate or the minimum change rate.

14. The temperature measurement method according to claim 12, wherein the average change rate obtained in the representative change rate calculation steps is an average change rate of all change rates other than a maximum change rate and a minimum change rate among first temperature change rates and second temperature change rates for each of the plurality of small regions.

15. The temperature measurement method according to claim 12, wherein, when a parameter serving as a cause of a change in the temperature in the large region has changed to a predetermined value or more, the change rate abnormality determination steps include determining that the first temperature measurement section measuring the target first measured temperature is not abnormal even though a difference between the first change rate deviation relating to the target first measured temperature and the average change rate exceeds the change rate deviation threshold value and determining that the second temperature measurement section measuring the target second measured temperature is not abnormal even though a difference between the second change rate deviation relating to the target second measured temperature and the average change rate exceeds the change rate deviation threshold value.

16. The temperature measurement method according to claim 12,
wherein the measurement target is a gas turbine including a compressor capable of compressing air and generating the compressed air, a plurality of combustors capable of generating combustion gas by burning fuel in the compressed air, and a turbine capable of being driven by the combustion gas,
wherein the turbine includes a turbine rotor capable of rotating around an axis, a turbine casing configured to cover outer circumference of the turbine rotor, and an exhaust casing connected to the turbine casing and in which exhaust gas that is combustion gas passing through the turbine rotor can circulate,
wherein the large region is an annular region centered on the axis in the exhaust casing,
wherein the plurality of small regions are regions into which the large region is divided in a circumferential direction with respect to the axis, and
wherein, when a flow rate of fuel to be supplied to the plurality of combustors has changed to a predetermined value or more, the change rate abnormality determination steps include determining that the first temperature measurement section measuring the target first measured temperature is not abnormal even though a difference between the first temperature change rate relating to the target first measured temperature and the average change rate exceeds the change rate deviation threshold value and determining that the second temperature measurement section measuring the target second measured temperature is not abnormal even though a difference between the second temperature change rate relating to the target second measured temperature and the average change rate exceeds the change rate deviation threshold value.

17. The temperature measurement method according to claim 10,
wherein the change rate calculation steps include
a short-time change rate calculation step of obtaining a short-time first temperature change rate, which is a change rate of the first measured temperature per short unit time, and a short-time second temperature change rate, which is a change rate of the second measured temperature per short unit time, and
a long-time change rate calculation step of obtaining a long-time first temperature change rate, which is a change rate of the first measured temperature per long unit time longer than the short unit time, and a long-time second temperature change rate, which is a change rate of the second measured temperature per long unit time,
wherein the representative change rate calculation steps include
a short-time representative change rate calculation step of obtaining a short-time representative change rate, which is the representative change rate for the short unit time, and
a long-time representative change rate calculation step of obtaining a long-time representative change rate, which is the representative change rate for the long unit time, and
wherein the change rate abnormality determination steps include
a short-time change rate abnormality determination step of determining whether or not the first temperature measurement section measuring the target first measured temperature and the second temperature measurement section measuring the target second measured temperature are abnormal using the short-time representative change rate, and
a long-time change rate abnormality determination step of determining whether or not the first temperature measurement section measuring the target first measured temperature and the second temperature measurement section measuring the target second measured temperature are abnormal using the long-time representative change rate.

18. The temperature measurement method according to claim 10, comprising a range abnormality determination step executed for each of the plurality of small regions,
wherein the range abnormality determination step includes
determining that the first temperature measurement section measuring the target first measured temperature is abnormal when the target first measured temperature is outside of the normal temperature range, and
determining that the second temperature measurement section measuring the target second measured temperature is abnormal when the target second measured temperature is outside of the normal temperature range.

19. The temperature measurement method according to claim 10, comprising a selection step of sending a temperature measured by a temperature measurement section determined not to be abnormal between the first temperature measurement section and the second temperature measurement section for each of the plurality of small regions to a control device for controlling an operation of the measurement target.
